(19) United States
(12) Patent Application Publication
(10) Pub. No.: US 2022/0226861 A1
(43) Pub. Date: Jul. 21, 2022

(54) A SEMILIQUID SURFACE WITH LIQUID AND SOLID REPELLENCE

(71) Applicant: Board of Regents, The University of Texas System, Austin, TX (US)

(72) Inventors: Lei Zhang, Austin, TX (US); Jyotirmoy Sarma, Austin, TX (US); Zongqi Guo, Austin, TX (US); Xianming Dai, Austin, TX (US)

(21) Appl. No.: 17/615,393

(22) PCT Filed: Jun. 9, 2020
(86) PCT No.: PCT/US2020/036755

§ 371 Date: Nov. 30, 2021

Related U.S. Application Data
(60) Provisional application No. 62/863,535, filed on Jun. 19, 2019.

(51) Int. Cl. B05D 3/14; C08G 77/44; B05D 5/08

(52) U.S. Cl. CPC B05D 3/148; B05D 5/08; C08G 77/44

(57) ABSTRACT

A method including providing a substrate having a surface, the surface is hydroxylated and exposing the hydroxylated surface of the substrate to a PDMS oligomer. The PDMS oligomer has a formula of: R₁—Si(CH₃)₂—(O—Si(CH₃)₂—)ₙ—O—Si(CH₃)₂—R₂ where at least one of R₁ or R₂ includes: —(CH₂)ₘ—R₃, R₃=one of —Cl, —O—(CH₂)ₓH, —SiCl₃, or —Si(O—(CH₂)ₓH)₃, x=0 to 10, m=0 to 10, n=10 to 500. R₃ undergoes hydrolysis such that one terminal Si atom of the PDMS oligomer is covalently bonded to the hydroxylated surface by a condensation reaction to form a grafted layer of PDMS polymers on the surface. An article including a substrate having a surface with a grafted layer of PDMS polymers thereon, each of the PDMS polymers have a formula of: -Q₁-Si(CH₃)₂—(O—Si(CH₃)₂—)ₙ—O—Si(CH₃)₂-Q2 where Q₁=—O— or —O—(CH₂)ₘ—O—, Q₂=-(-Q₁-Si(CH₃)₂—(O—Si(CH₃)₂—)ₙ—O—Si(CH₃)₂—)ₚ-Q₃, Q₃=—OH, —(CH₂)ₘ—OH, —Si(OH)₃, or —(CH₂)ₘ—Si(OH)₃, m=0 to 10, n=10 to 500, p=0 to 500, Q₁=end of the PDMS polymer covalently bonded to the surface.

### CROSS REFERENCE TO RELATED APPLICATION

Pursuant to 35 U.S.C. § 119(e), this application claims priority to U.S. Provisional Application Ser. No. 62/863,535, filed Jun. 19, 2019, the contents of which are hereby incorporated by reference in its entirety.

### TECHNICAL FIELD

This application is directed, in general, to methods of treating surfaces to increase liquid repellence and to the treated surface itself and more specifically, to methods of treating a substrate surface with polydimethylsiloxane (PDMS) oligomer to form a grafted layer of PDMS polymers on the surface and to articles having such a grafted layer.

### BACKGROUND

The treatment of solid surfaces that can better repel liquids is of broad interest. Present surface treatments include forming superhydrophobic or superoleophobic surfaces which rely on air lubricant, or, on liquid-infused surfaces which rely on a liquid lubricant. Often, however, such treated surfaces suffer from a lack of durability e.g., due the loss of air or liquid lubricant or topography surface damage. Thus, there is a continuing need to develop surface treatments and treated surfaces that can repel liquid and retain their repellence for extended durations.

### SUMMARY

The present disclosure provides in one embodiment, a method that includes providing a substrate having a surface, wherein the surface is hydroxylated and exposing the hydroxylated surface of the substrate to a PDMS oligomer. The PDMS oligomer having a formula of:

R₁—Si(CH₃)₂—(O—Si(CH₃)₂—)ₙ—O—Si(CH₃)₂—R₂

where at least one of R₁ or R₂ includes: —(CH₂)ₘ—R₃, R₃ is one of —Cl, —O—(CH₂)ₓH, —SiCl₃, or —Si(O—(CH₂)ₓH)₃, x is an integer in a range from 0 to 10, m is an integer in a range from 0 to 10, n is an integer in a range from 10 to 500. The R₃ of the PDMS oligomer undergoes hydrolysis such that one terminal Si atom of the PDMS oligomer is covalently bonded to the hydroxylated surface by a condensation reaction to form a grafted layer of PDMS polymers on the surface

Another embodiment of the disclosure is an article including a substrate having a surface with a grafted layer of PDMS polymers thereon, wherein each of the PDMS polymers have a formula of:

-Q₁-Si(CH₃)₂—(O—Si(CH₃)₂—)ₙ—O—Si(CH₃)₂-Q₂

where Q₁ is one of —O— or —O—(CH₂)ₘ—O—, Q₂ is -(-Q₁-Si(CH₃)₂—(O—Si(CH₃)₂—)ₙ—O—Si(CH₃)₂—)ₚ-Q₃, Q₃ is one of —OH, —(CH₂)ₘ—OH, —Si(OH)₃, or —(CH₂)ₘ—Si(OH)₃, m is an integer in a range from 0 to 10, n is an integer in a range from 10 to 500, p is an integer in a range from 0 to 500, and the Q₁ is an end of the PDMS polymer covalently bonded to the surface.

### BRIEF DESCRIPTION

For a more complete understanding of the present disclosure, reference is now made to the following detailed description taken in conjunction with the accompanying FIGUREs. Reference is now made to the following descriptions taken in conjunction with the accompanying drawings, in which:

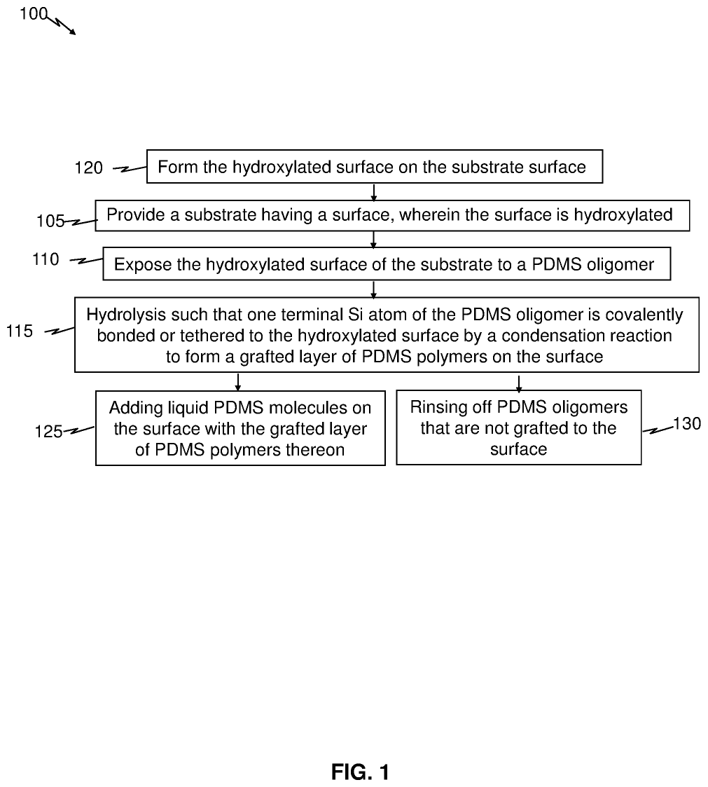

FIG. 1 presents a flow diagram of example method embodiments of the disclosure;

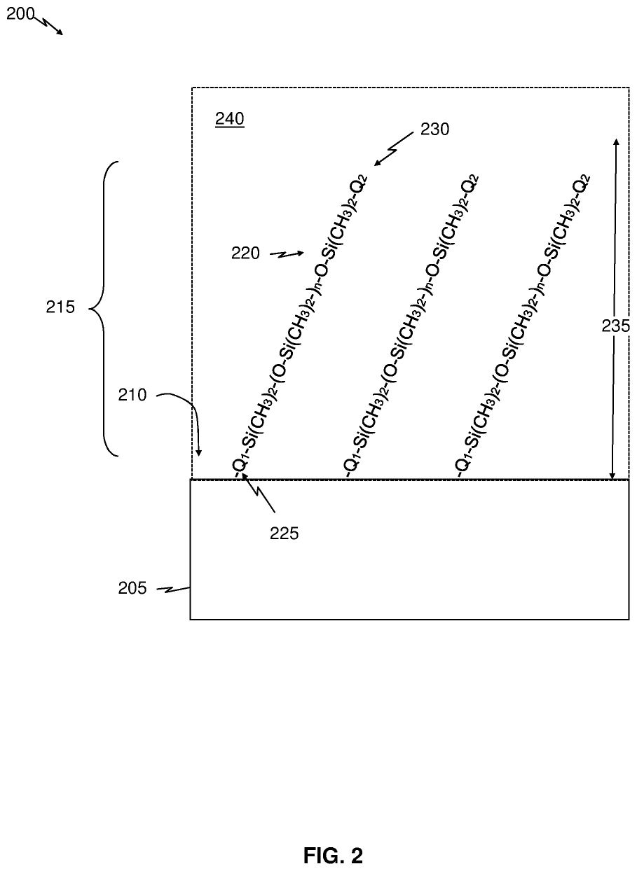

FIG. 2 presents a conceptual schematic representation of article embodiments of the disclosure;

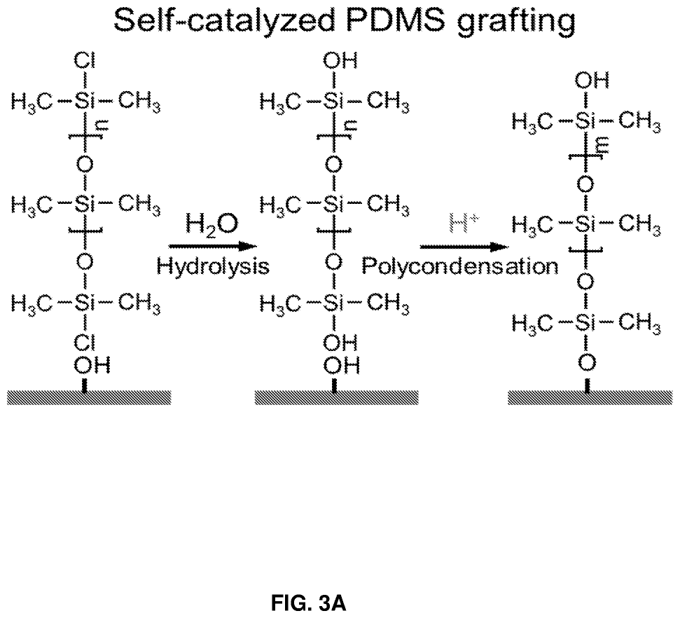

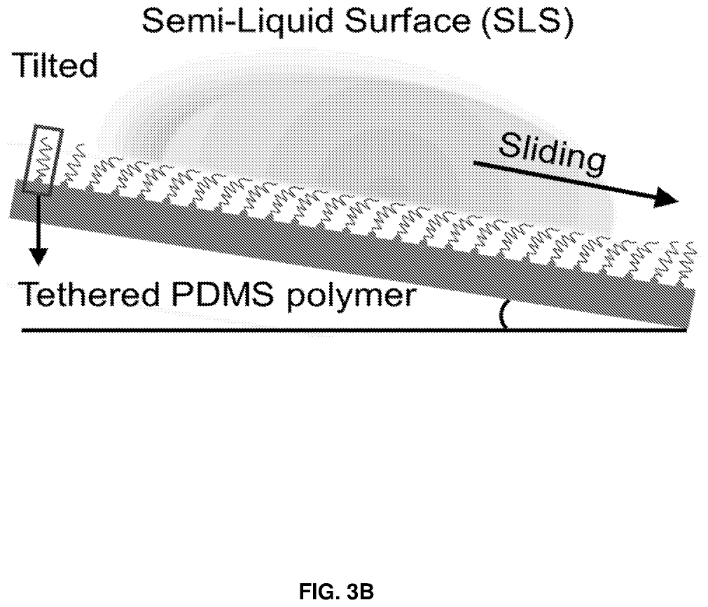

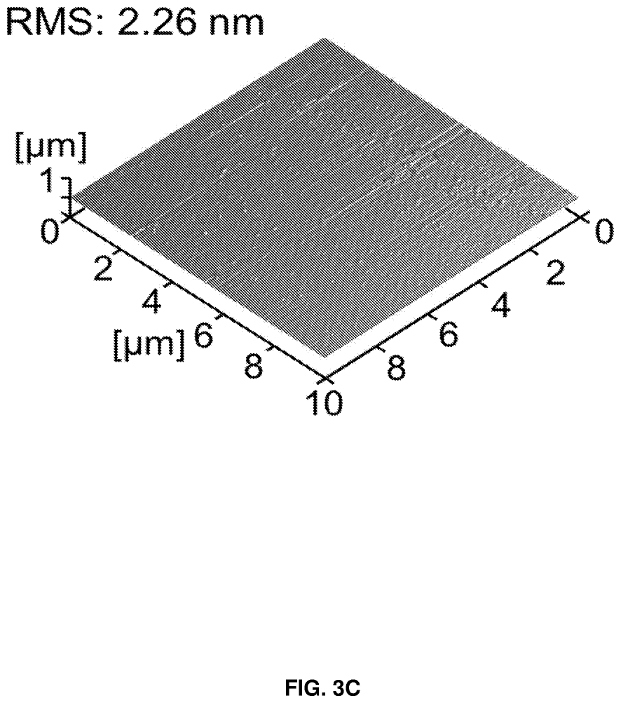

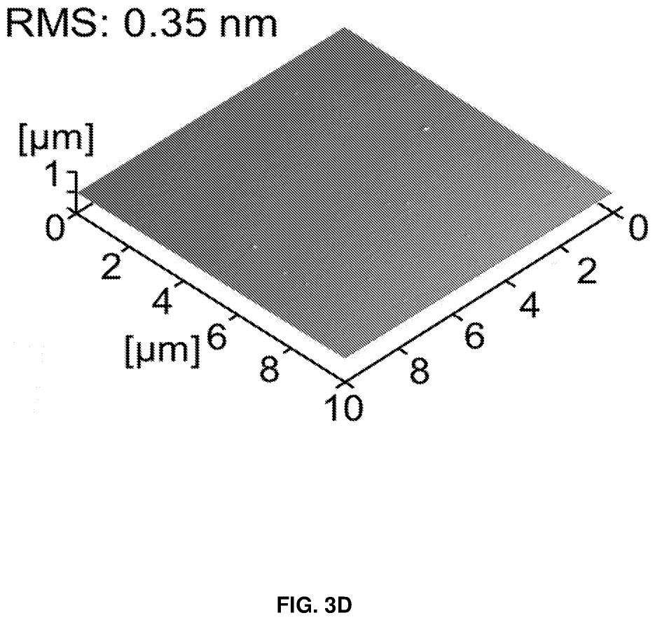

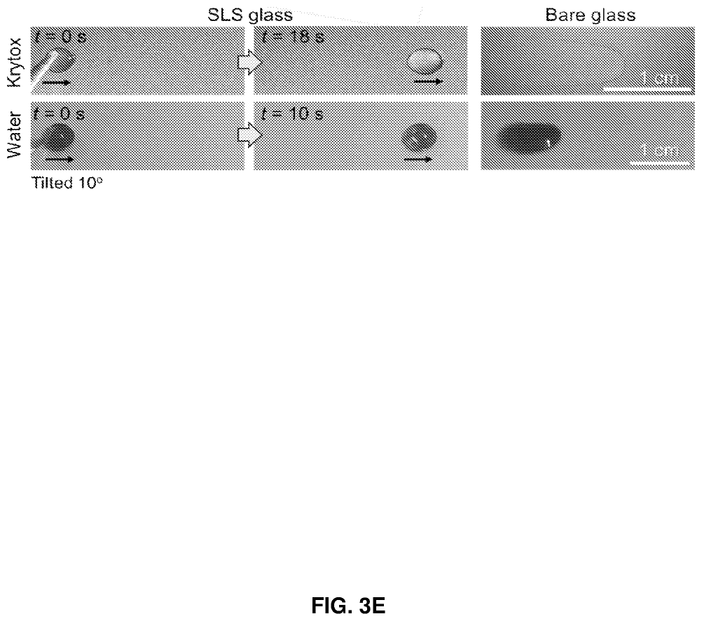

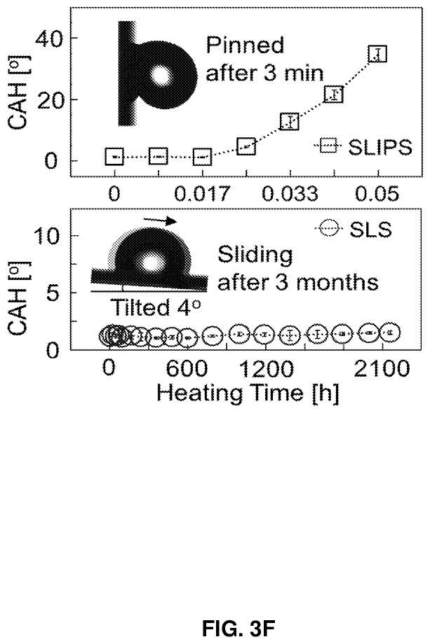

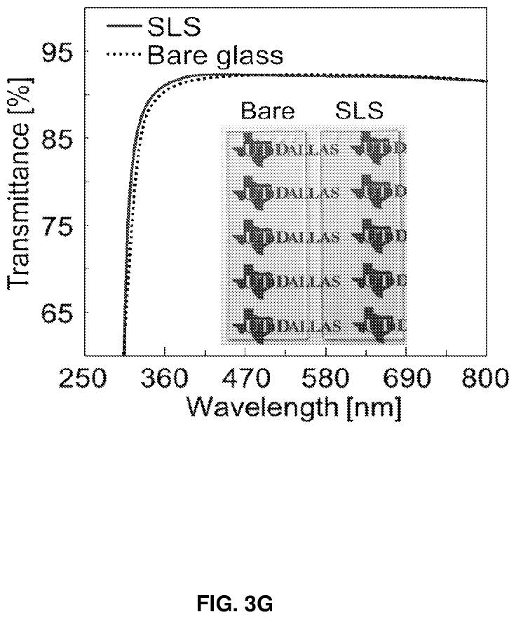

FIG. 3A presents a schematic representation of one-step self-catalyzed grafting of chlorine-terminated PDMS polymer on a hydroxylated substrate;

FIG. 3B presents a schematic representation of a droplet sliding on a tilted semi-liquid surface (SLS);

FIG. 3C presents an atomic force microscope (AFM) image of a glass surface coated with small molecular chlorosilane;

FIG. 3D presents an AFM image of with SLS on glass grafted with flexible PDMS polymer;

FIG. 3E presents time-sequence images of liquid repellency of 2 μL Krytox101 and 20 μL water on SLS with glass substrate and bare glass at a tilted angle of 10°;

FIG. 3F a comparison of contact angle hysteresis (CAH) as a function of heating time at 105° C. on SLS with the silicon substrate and semi-liquid-infused surface (SLIPS) made by black silicon infused with Krytox101 and the insets show that 5 μL water droplet is pinned on SLIPS after 3 min due to lubricant evaporation but it remains mobile on SLS after more than 3 months;

FIG. 3G presents 3G UV/Vis spectra of SLS on glass and bare glass, showing the optical transparency of SLS;

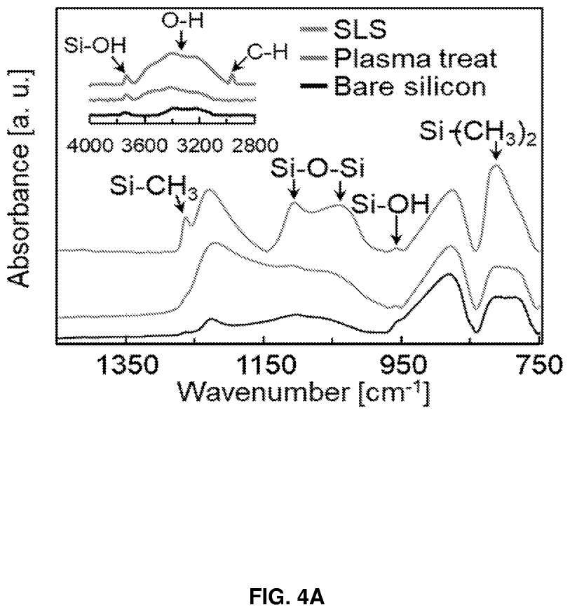

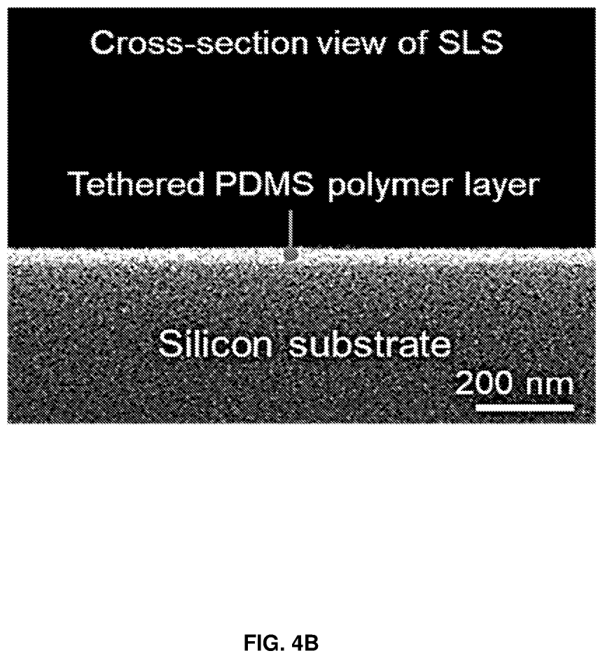

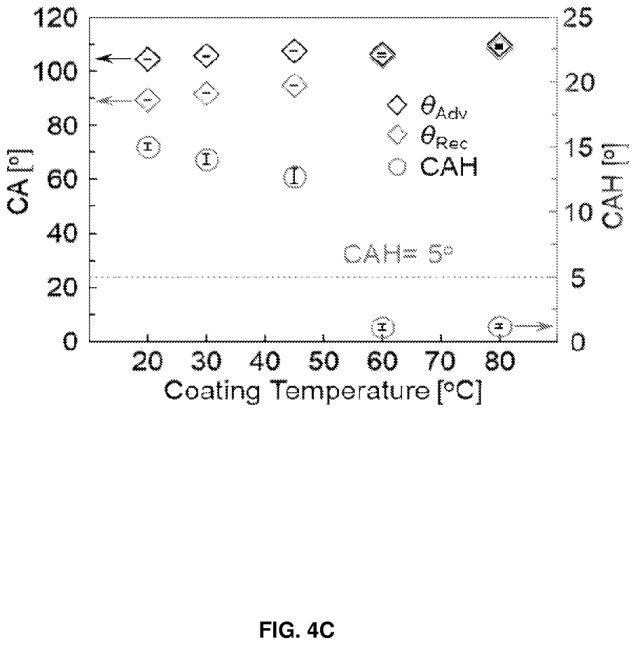

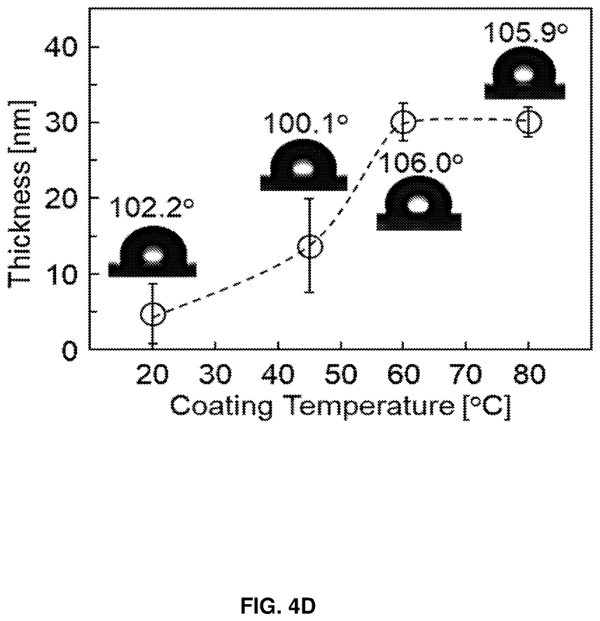

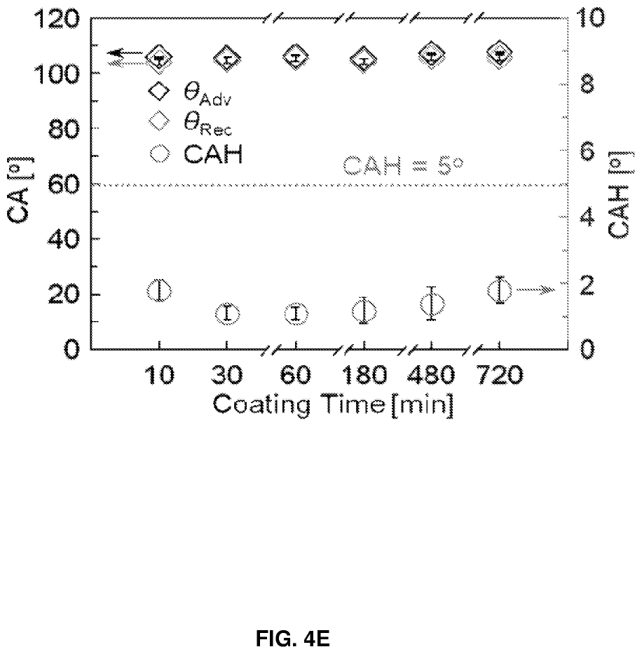

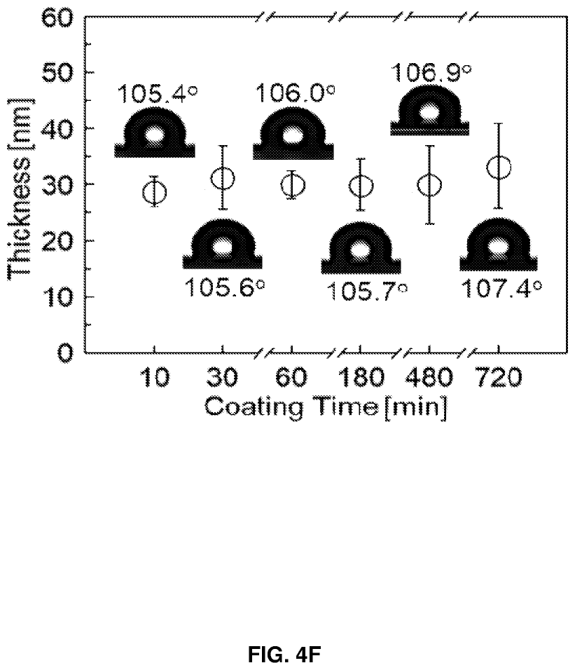

FIG. 4A presents Attenuated Total Reflection Fourier Transform Infrared (ATR-FTIR) spectra of chemical compositions and synthesis optimization of a grafted PDMS polymer for the fabrication of SLS;

FIG. 4B presents a scanning electron microscope (SEM) image of a cross-sectional view of SLS on silicon for a grafting time of 60 min, and grafting temperature of 60° C.;

FIG. 4C presents contact angle (CA) and CAH of water droplets in SLS as a function of grafting temperature for a grafting time of 60 min, the dashed line represents the water CAH of 5°;

FIG. 4D presents SLS corresponding thicknesses measured by an ellipsometer as a function of grafting temperature and the insets show the contact angles of water droplets on SLS;

FIG. 4E presents CA and CAH of water droplets in SLS as a function of grafting temperature for a grafting time of 60 min, the dashed line represents the water CAH of 5°;

FIG. 4F presents SLS corresponding thicknesses measured by an ellipsometer as a function of grafting temperature and the insets show the contact angles of water droplets on SLS;

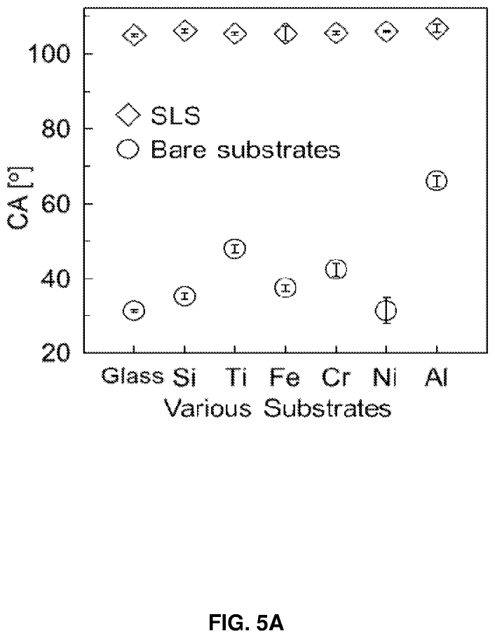

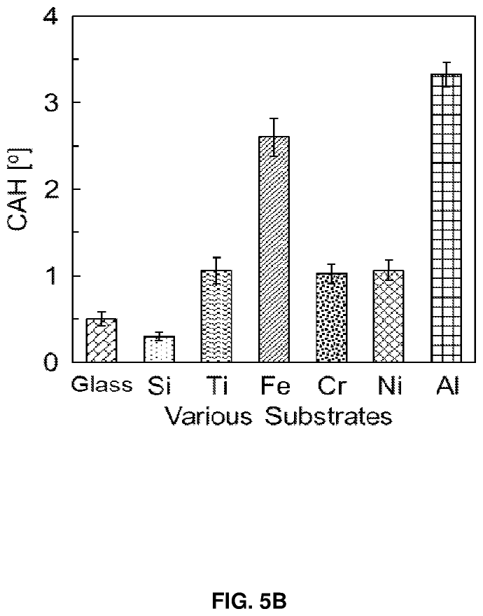

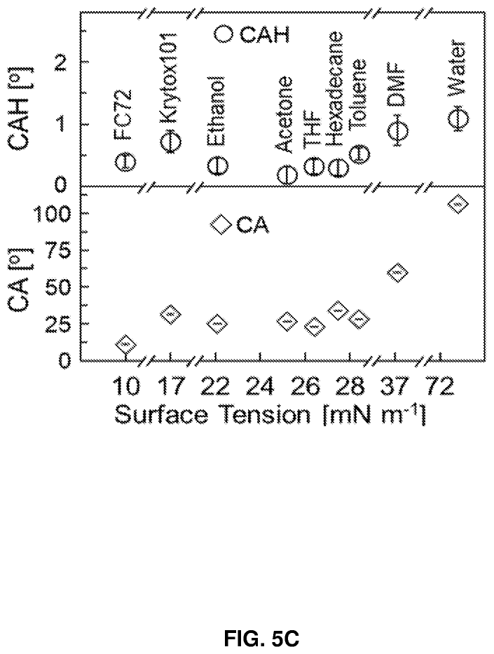

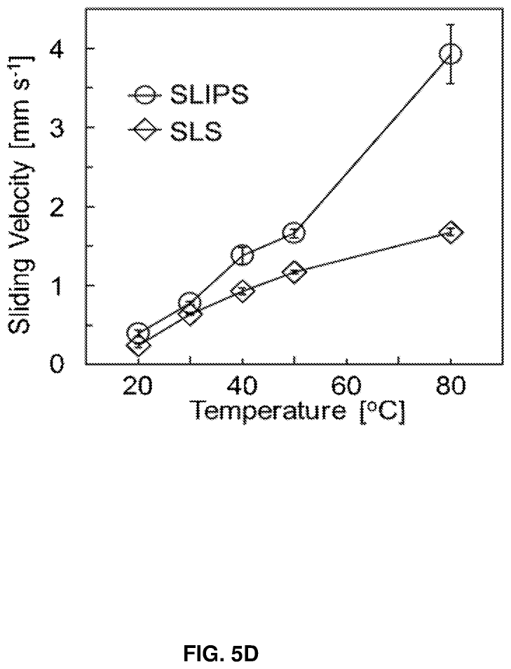

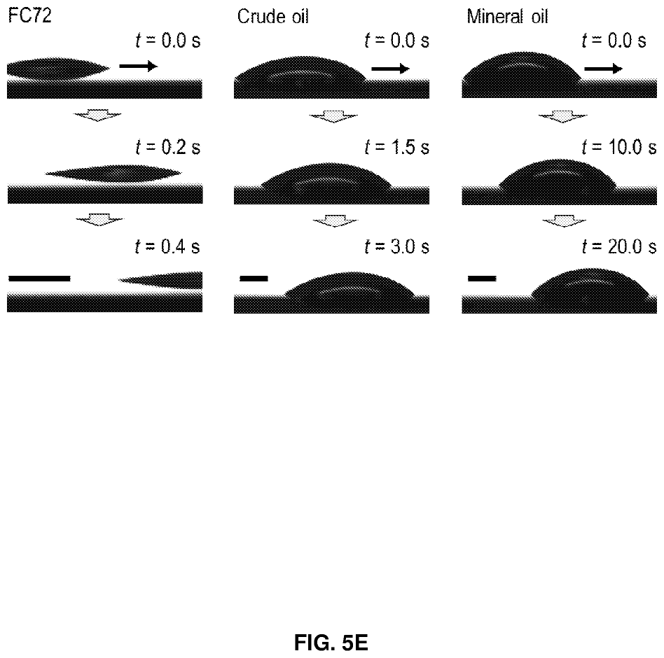

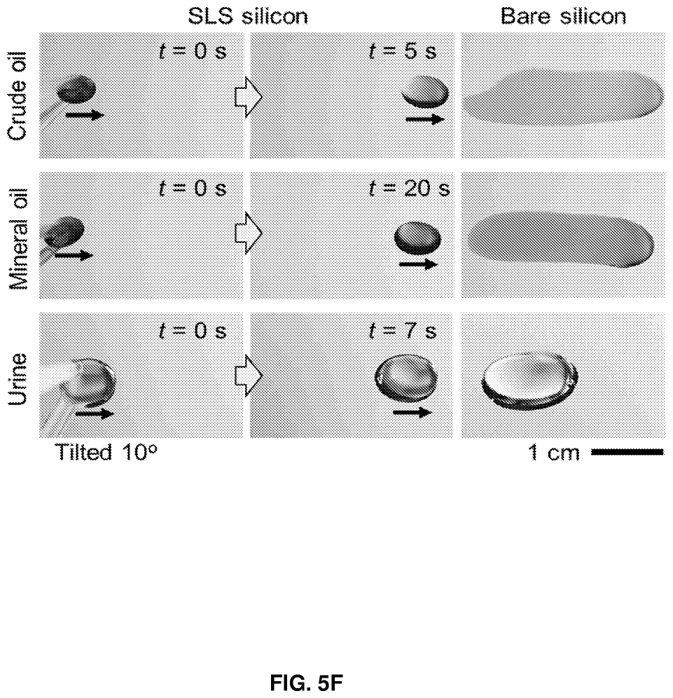

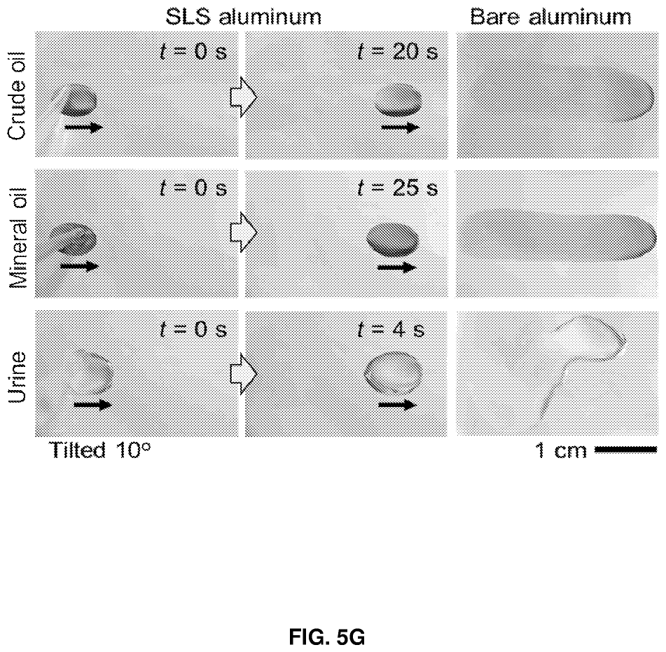

FIG. 5A shows the CA of water on different substrates before and after coating with SLS;

FIG. 5B shows the CAH of toluene on SLS coatings on different substrates;

FIG. 5C shows the CA and CAH of various liquids on SLS coatings of silicon;

FIG. 5D shows the temperature-dependent sliding velocity of 5 μL hexadecane on SLS with a silicon substrate and SLIPS (anodic aluminum oxide, AAO, infused with Krytox101) at the tilted angle of 3°;

FIG. 5E presents time-sequence images of ˜1 μL droplet of fluorocarbon liquid (FC72) and 5 μL droplets of crude oil and mineral oil sliding down SLS at the tilted angle of 10° and the scale bars are 1 mm;

FIG. 5F shows the liquid repellency of crude oil, mineral oil, and urine on SLS coated silicon versus bare silicon;

FIG. 5G shows the liquid repellency of crude oil, mineral oil, and urine on SLS coated aluminum foil versus bare aluminum foil;

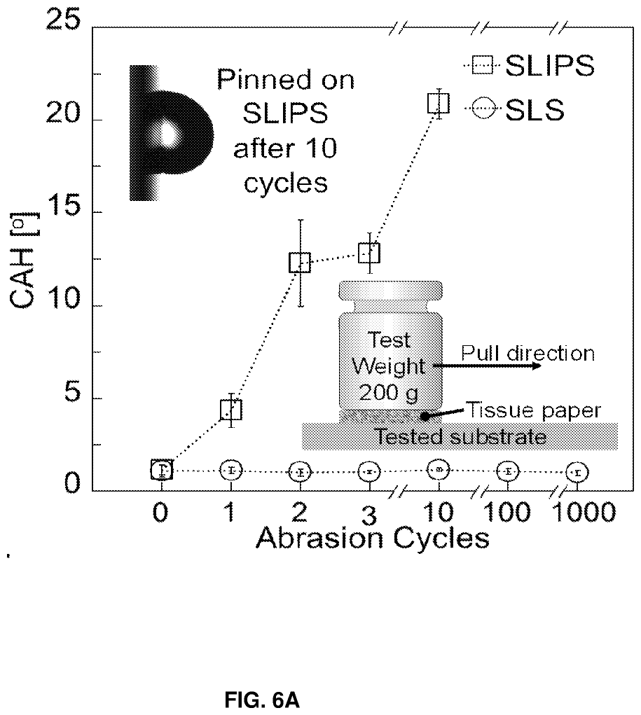

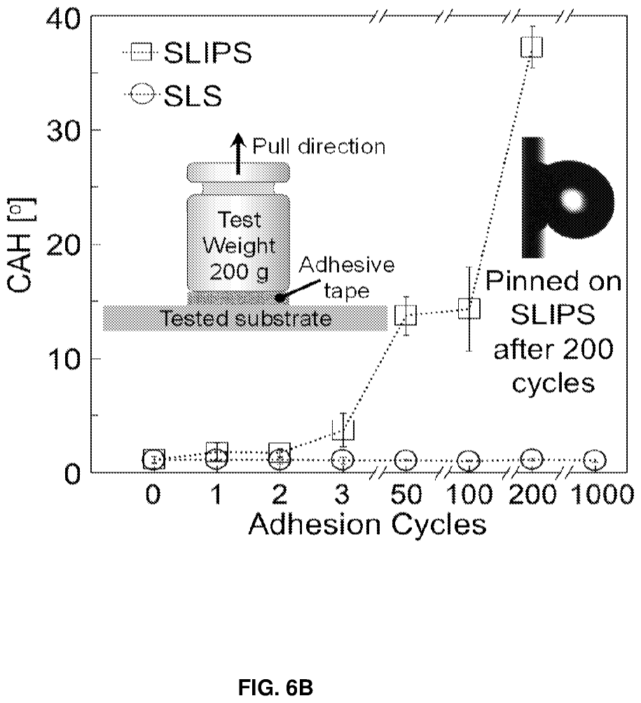

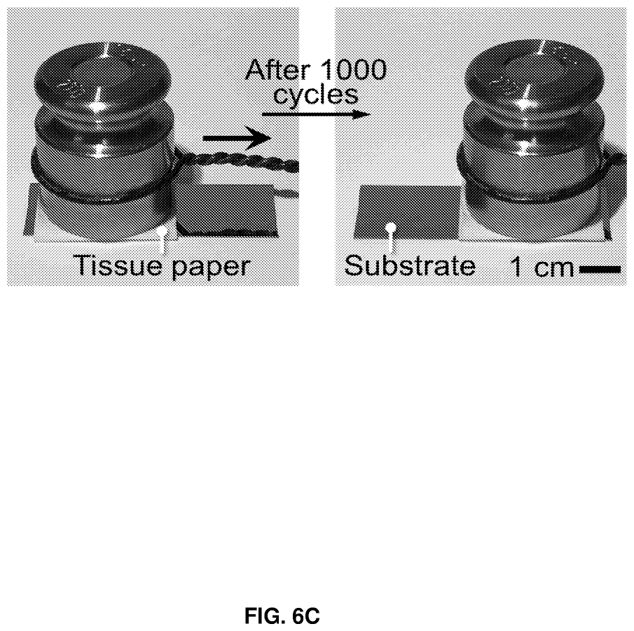

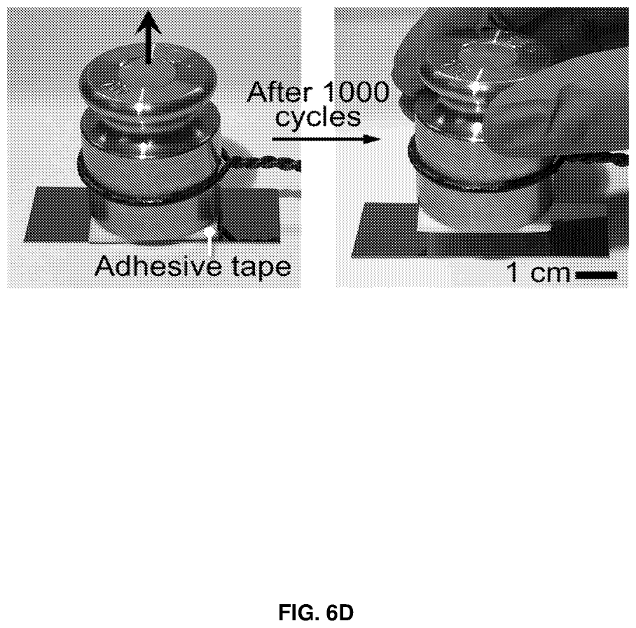

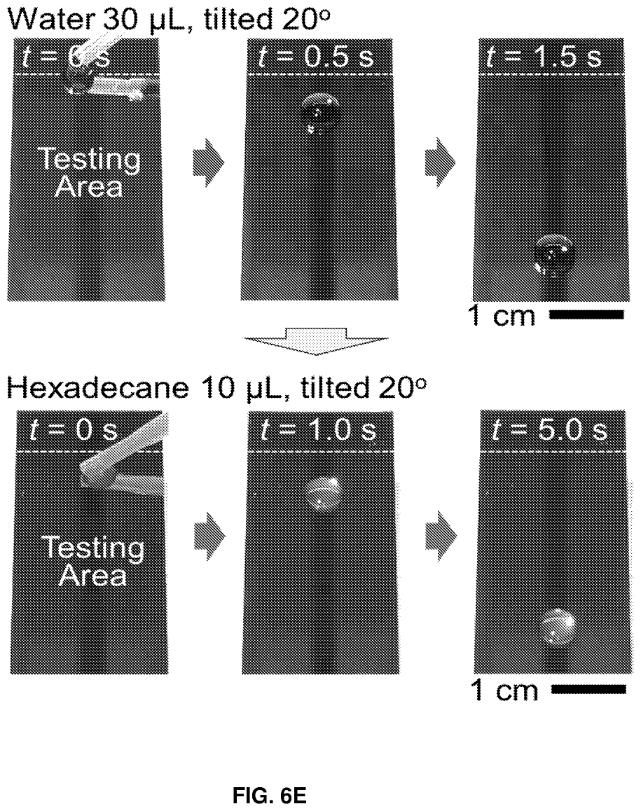

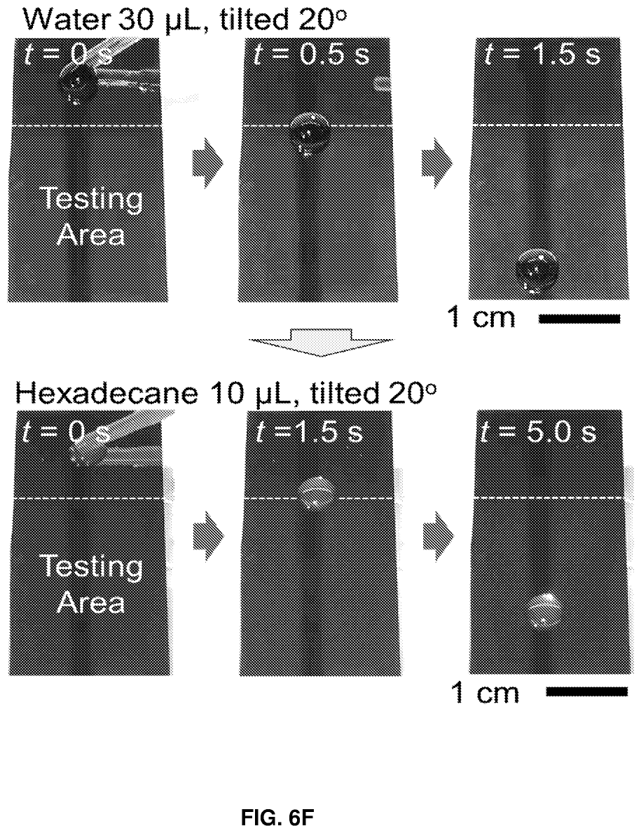

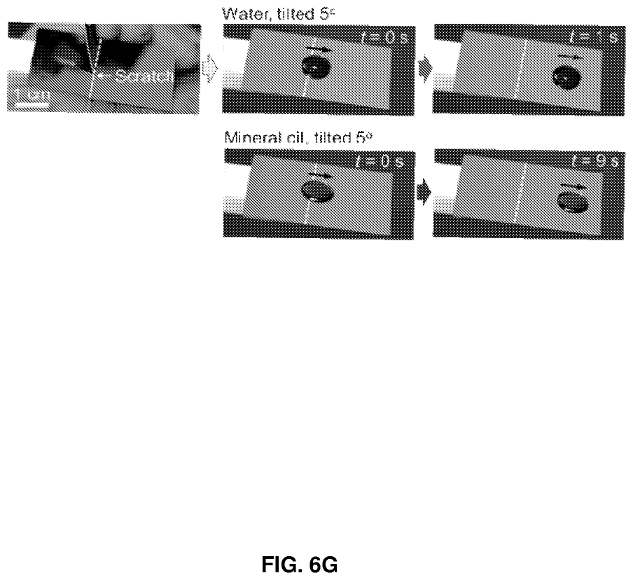

FIG. 6A presents the durability of liquid repellency of water CAH on SLS on silicon and SLIPS (black silicon infused with Krytox101) after continuous abrasion tests with tissue paper and the inset shows the abrasion test scheme;

FIG. 6B presents the durability of liquid repellency of water CAH on SLS on silicon and SLIPS (black silicon infused with Krytox101) after continuous adhesion tests with adhesive tape and the inset shows the adhesion test scheme;

FIG. 6C presents photographs of an abrasion test scheme;

FIG. 6D presents photographs of an adhesion test scheme;

FIG. 6E presents photographs showing the repellency of water and hexadecane on SLS after 1000 cycles of the abrasion test;

FIG. 6F presents photographs showing the repellency of water and hexadecane on SLS after 1000 cycles of the adhesion test;

FIG. 6G presents photographs showing the liquid repellency of water and mineral oil on SLS after scratch damage;

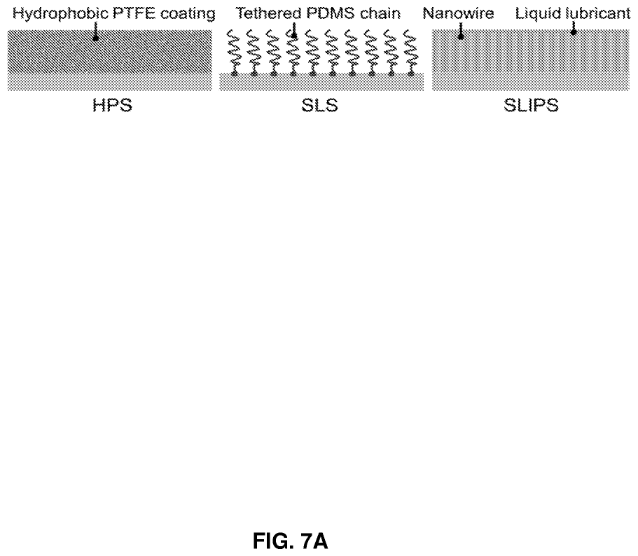

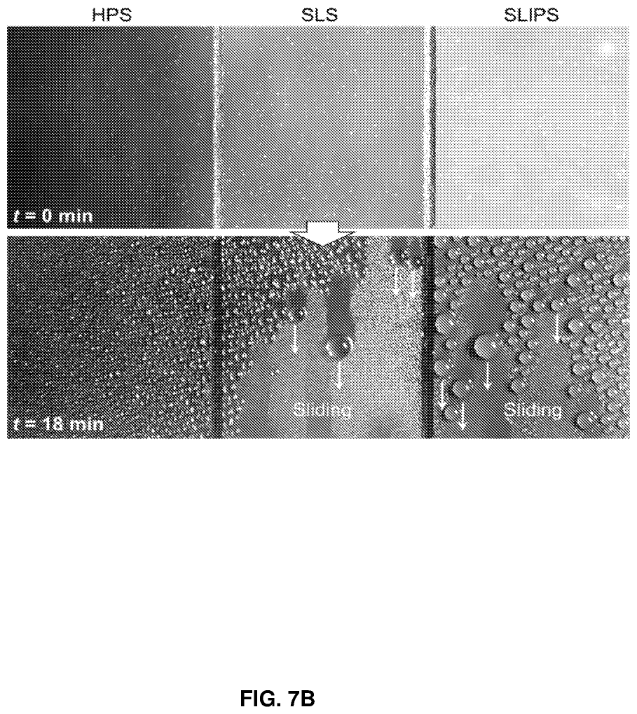

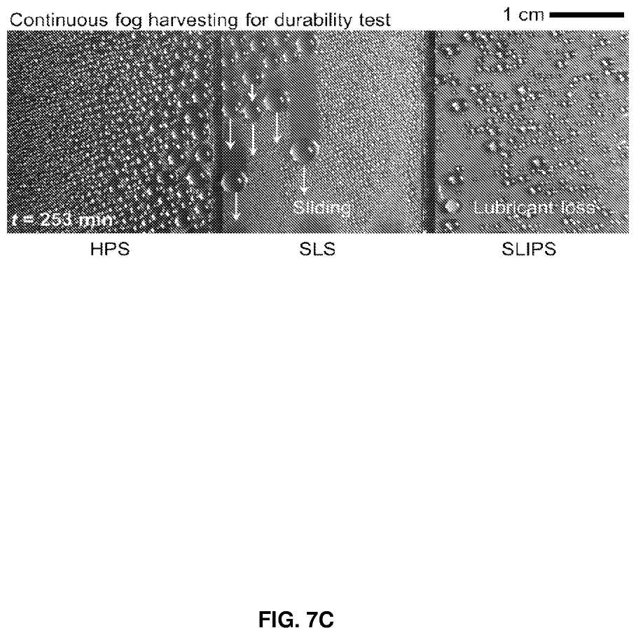

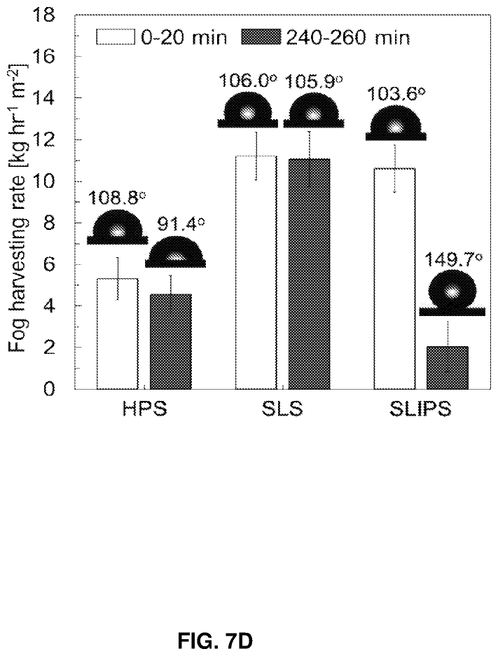

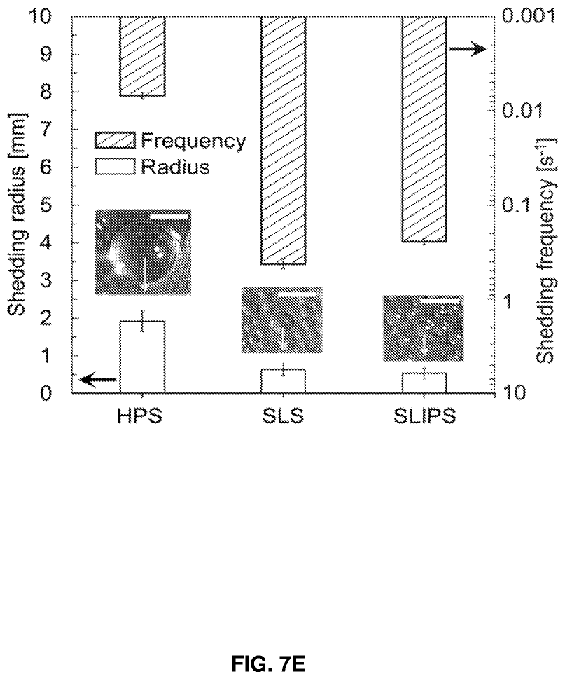

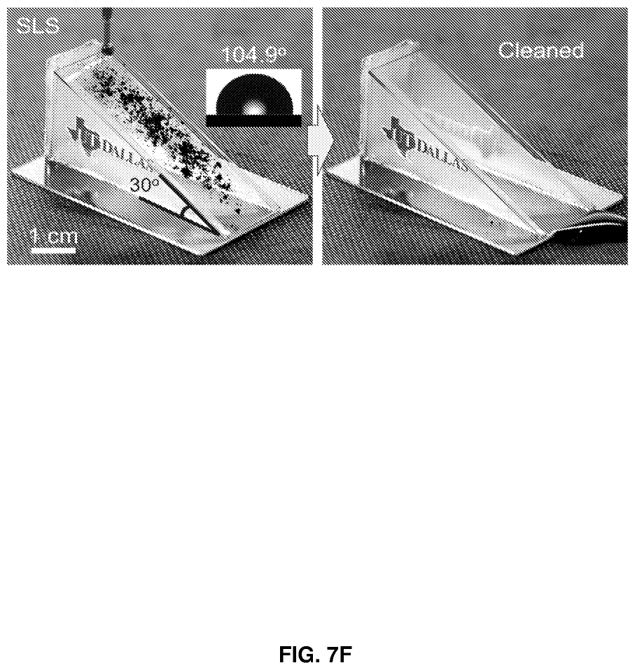

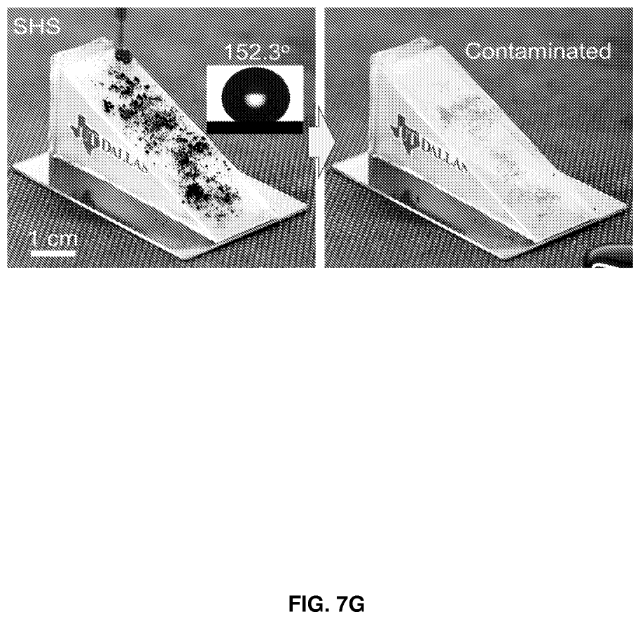

FIG. 7A presents a schematic representation of PTFE-coated hydrophobic surface (HPS), SLS and SLIPS;

FIG. 7B presents photographs comparing fog harvesting on HPS, SLS and SLIPS surfaces for 0-20 min.;

FIG. 7C presents photographs comparing durable fog harvesting on HPS, SLS and SLIPS surfaces for 253 min.;

FIG. 7D show a comparison of fog harvesting rates on HPS, SLS and SLIPS and the insets present the water CA on different surfaces before and after the fog harvesting tests;

FIG. 7E shows variations of the average droplet shedding radius and shedding frequency on HPS, SLS and SLIPS for 0-20 min during fog harvesting and the insets present photographs of shedding water droplets on the three surfaces for size comparison;

FIG. 7F presents photographs illustrating self-cleaning ability of iron oxide particles on SLS on glass, with a water CA of 104.9° and the substrate tilted at 30°;

FIG. 7G presents photographs illustrating self-cleaning ability of iron oxide particles on a superhydrophobic surface (SHS) made with commercial NeverWet® coating, with a water CA of 152.3° and the substrate tilted at 30°;

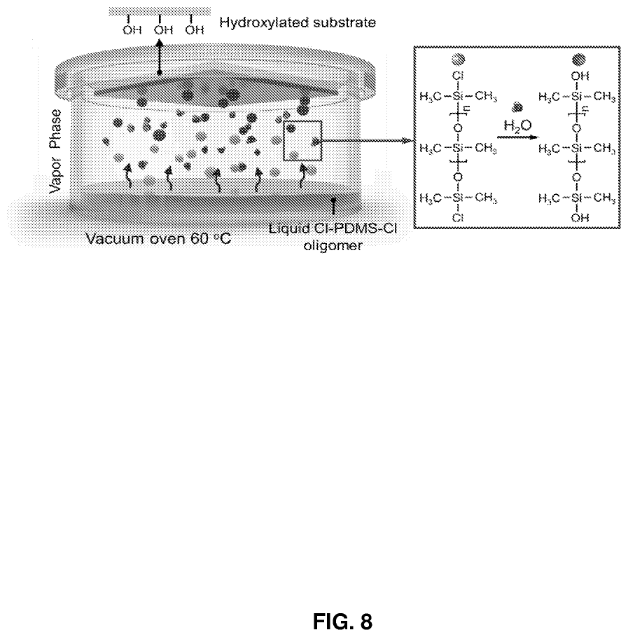

FIG. 8 presents a schematic representation of preparation of SLS by vapor phase in a vacuum oven;

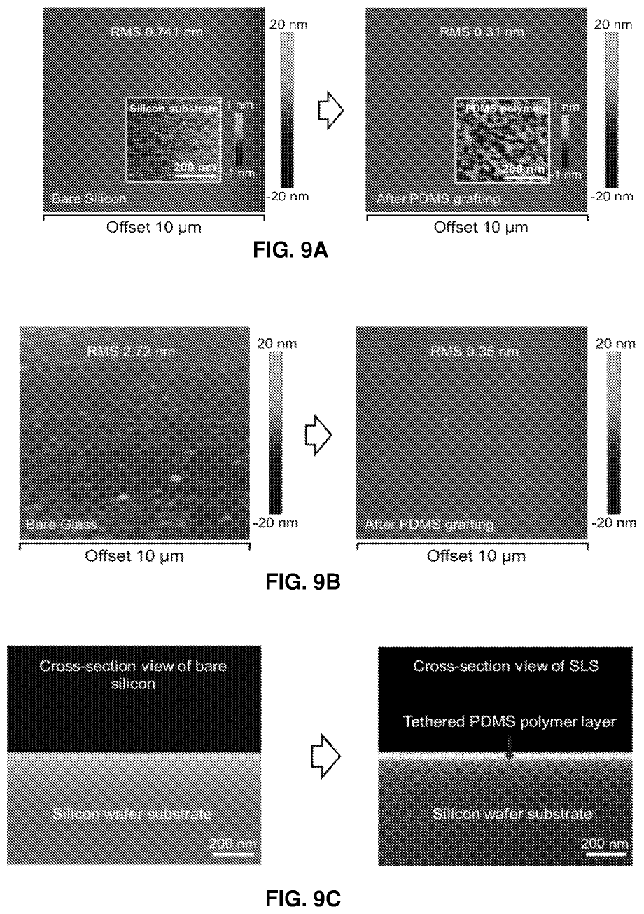

FIG. 9A presents AFM images of a silicon surface before and after PDMS grafting;

FIG. 9B presents additional AFM images of a silicon surface before and after PDMS grafting;

FIG. 9C presents SEM images of a cross-sectional view of silicon before and after PDMS grafting;

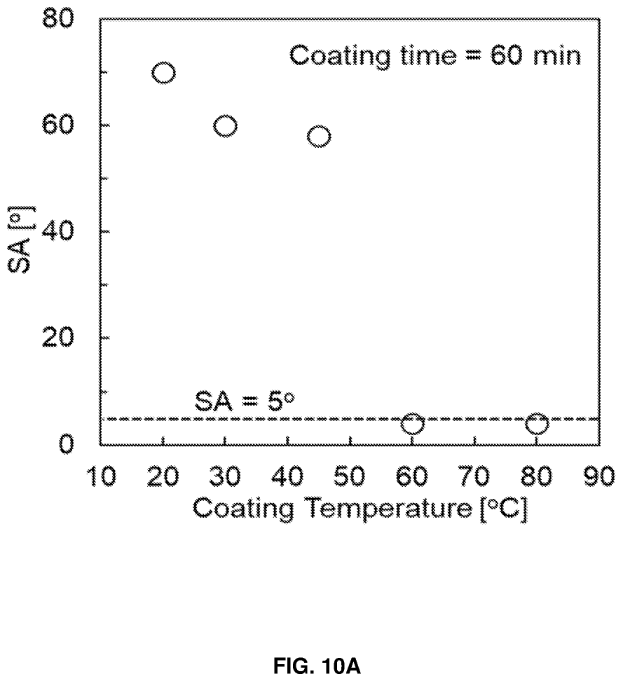

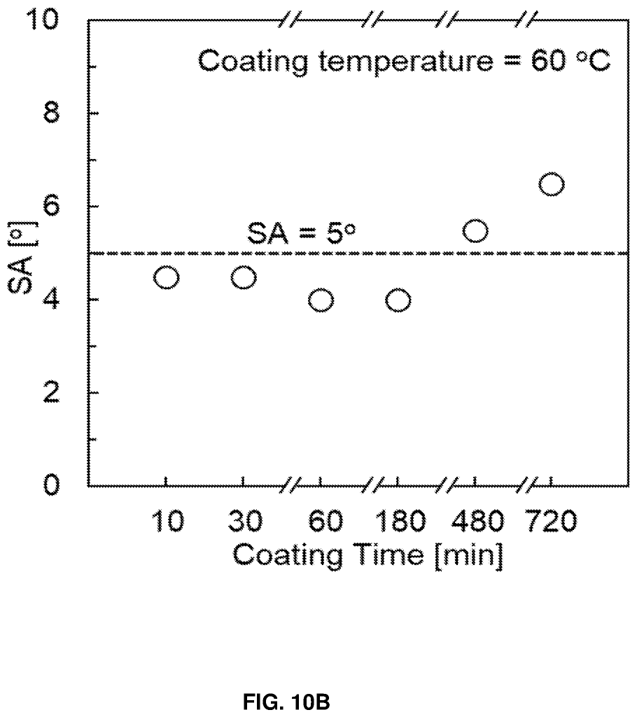

FIG. 10A shows sliding angle (SA) of a 5 μL water droplet on a SLS coating of silicon with a coating time of 60 min and different coating temperatures;

FIG. 10B shows SA of a 5 μL water droplet on a SLS coating of silicon with a coating temperature of 60° C. and different coating times;

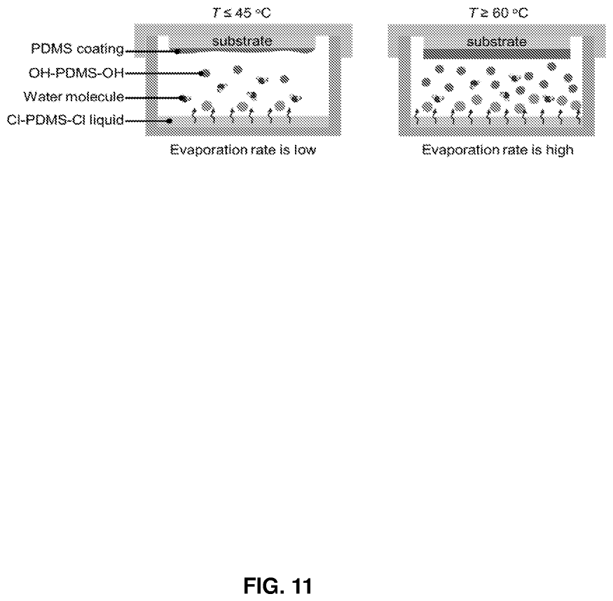

FIG. 11 presents a schematic representation showing the probable influence of temperature on the evaporation of liquid Cl-PDMS-Cl in a vacuum oven;

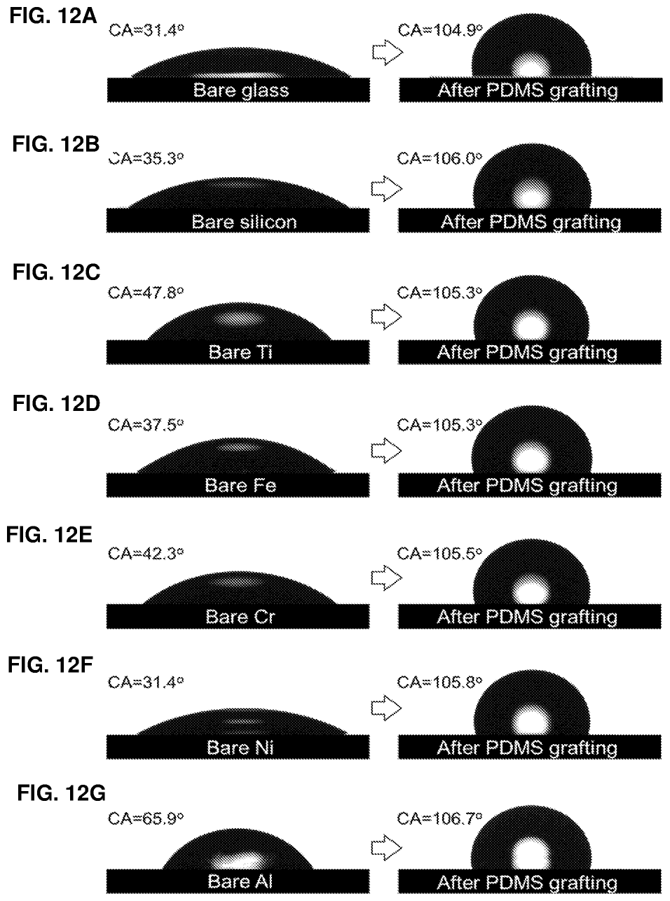

FIG. 12A present cross-sectional images of water (5 μL) CA on a glass substrate before and after PDMS coating;

FIG. 12B present cross-sectional images of water (5 μL) CA on a silicon substrate before and after PDMS coating;

FIG. 12C present cross-sectional images of water (5 μL) CA on a Ti substrate before and after PDMS coating;

FIG. 12D present cross-sectional images of water (5 μL) CA on a Fe substrate before and after PDMS coating;

FIG. 12E present cross-sectional images of water (5 μL) CA on a Cr substrate before and after PDMS coating;

FIG. 12F present cross-sectional images of water (5 μL) CA on a Ni substrate before and after PDMS coating;

FIG. 12G present cross-sectional images of water (5 μL) CA on a Al substrate before and after PDMS coating;

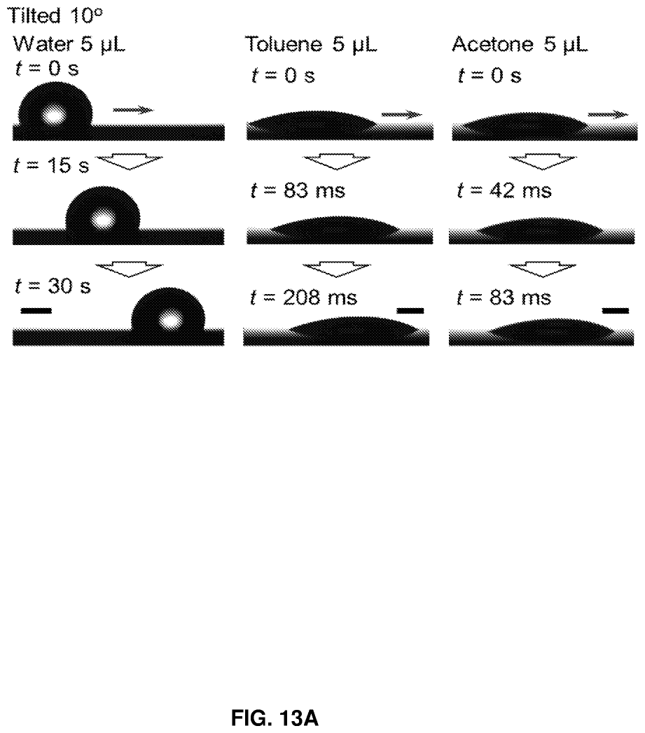

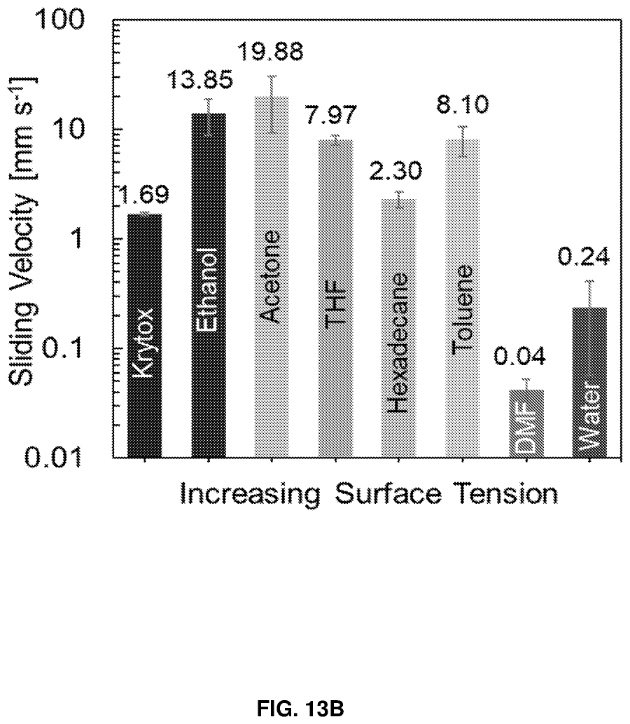

FIG. 13A present cross-sectional images of water, toluene and acetone (5 μL) sliding down the SLS coating of silicon with the tilted angle of 10° with scale bars of 1 mm;

FIG. 13B shows a comparison of different types of liquids (5 μL) down the SLS coating of silicon with the tilted angle of 10°;

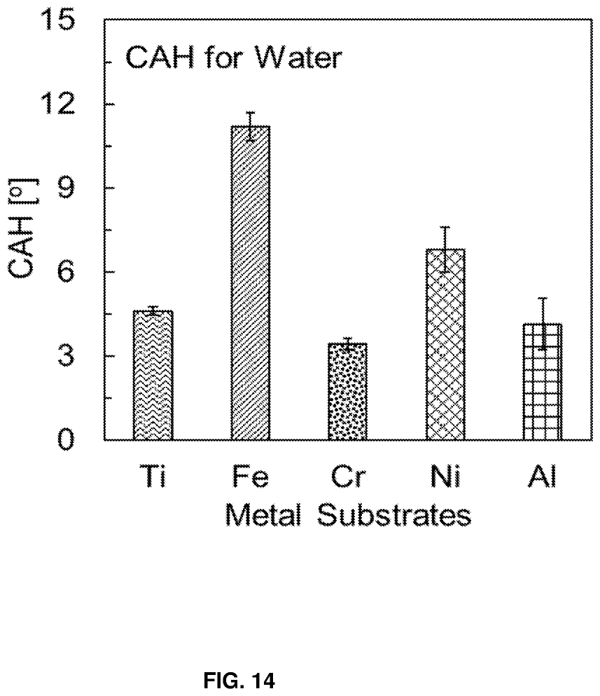

FIG. 14 presents a comparison of CAH for water on SLS coated on different metal substrates;

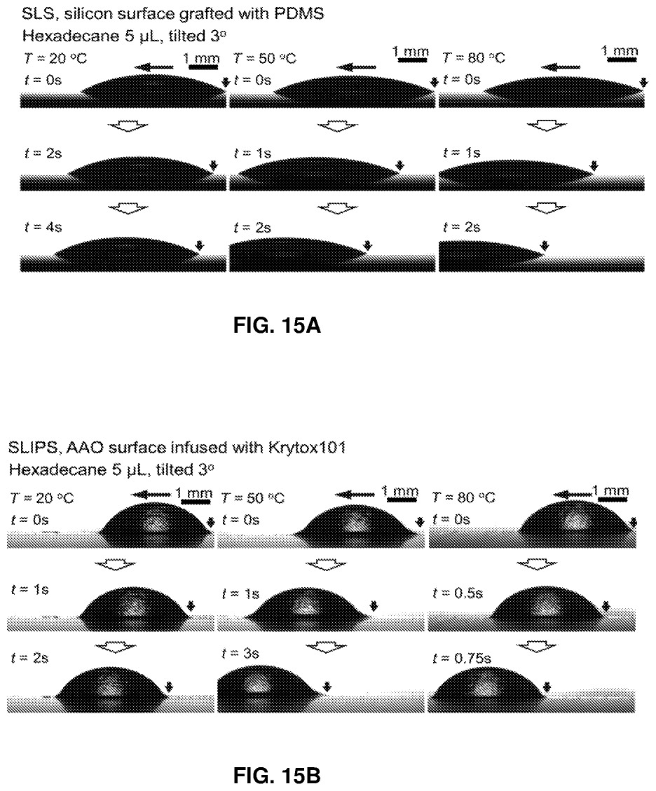

FIG. 15A present cross-sectional images of hexadecane droplets sliding on SLS coated silicon at different temperatures;

FIG. 15B present cross-sectional images of hexadecane droplets sliding on SLIPS (AAO surface infused with Krytox 101) at different temperatures;

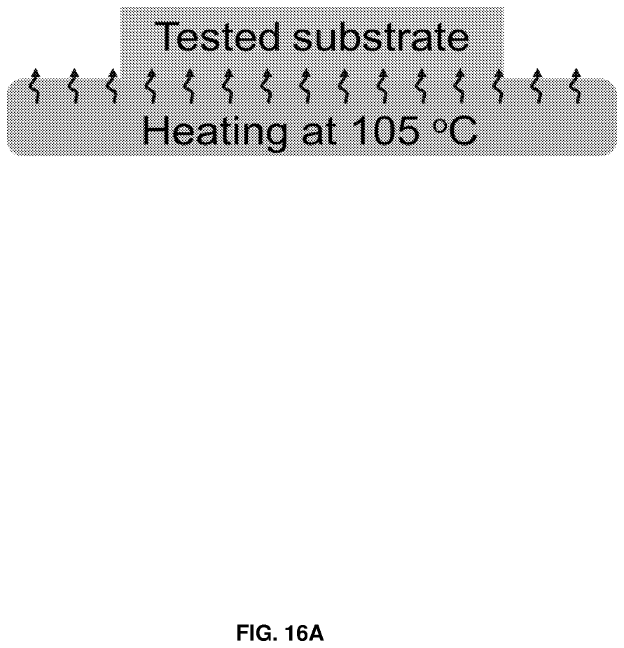

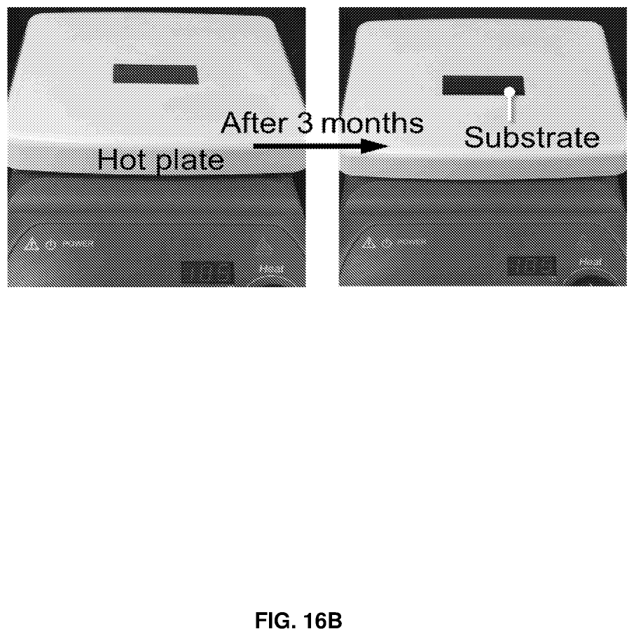

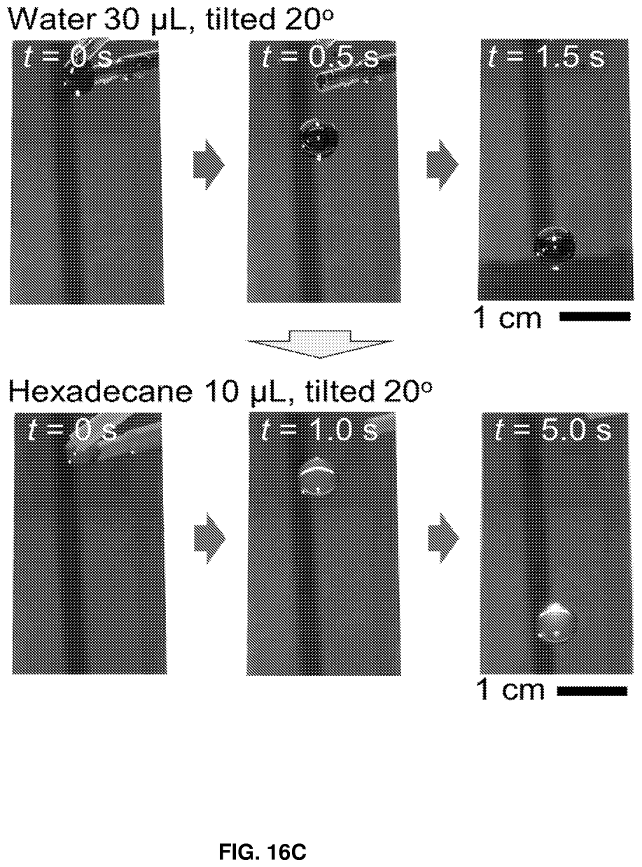

FIG. 16A presents a schematic representation of high-temperature aging test heating at 105° C.;

FIG. 16B present photographs of a high-temperature aging test heating at 105° C.;

FIG. 16C presents photographs showing liquid repellency of SLS to water and hexadecane after high-temperature aging for over 3 months;

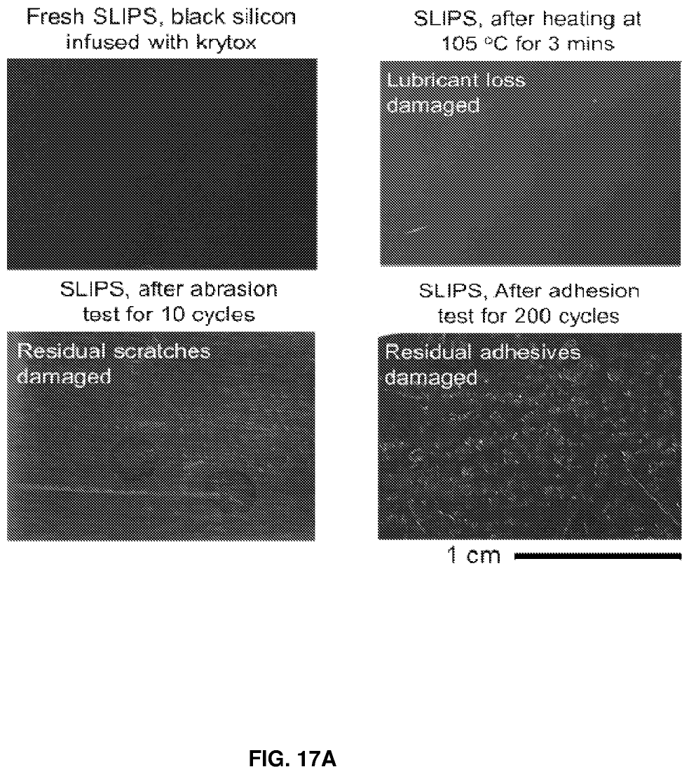

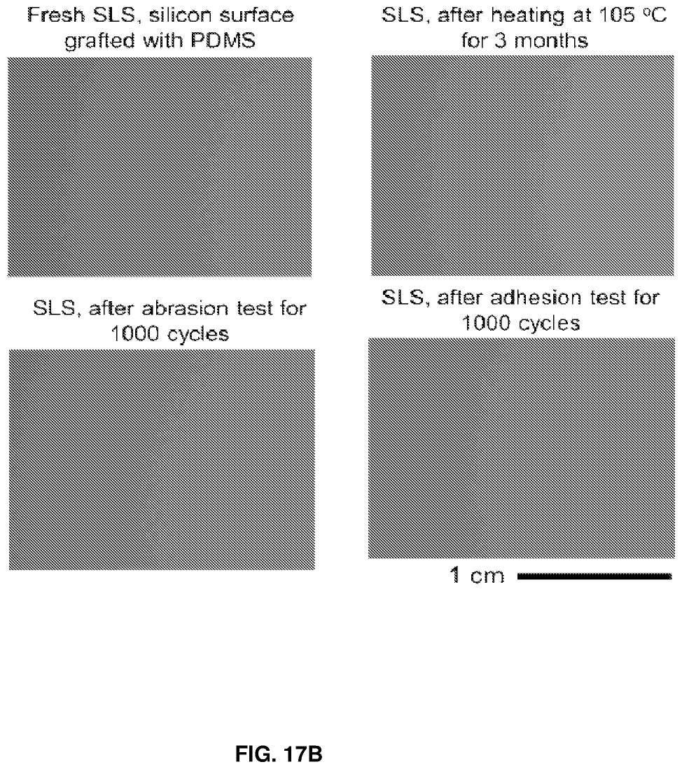

FIG. 17A presents images show the surface of SLIPS (black silicon infused with Krytox101) before and after harsh durability tests of high-temperature aging, abrasion and adhesion for different durations;

FIG. 17B presents images show the surface of SLS (PDMS-grafted silicon) before and after harsh durability tests of high-temperature aging, abrasion and adhesion for different durations;

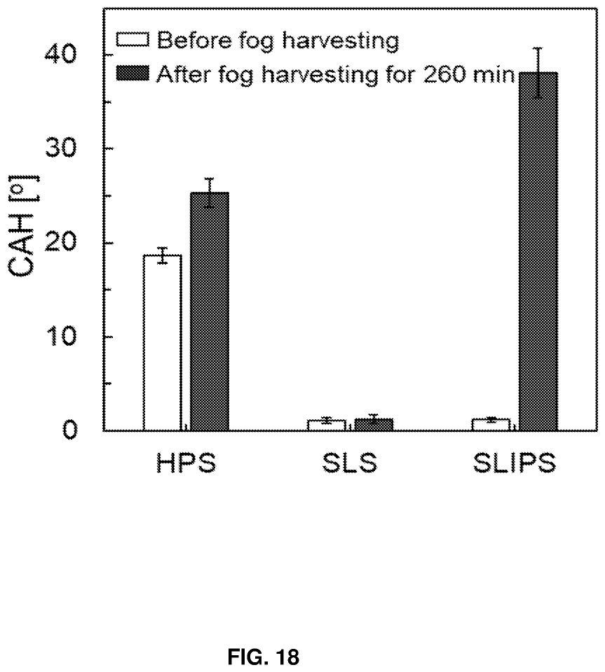

FIG. 18 shows the water CAH of PTFE-coated hydrophobic surface (HPS), SLS and SLIPS before and after fog harvesting test for 260 min;

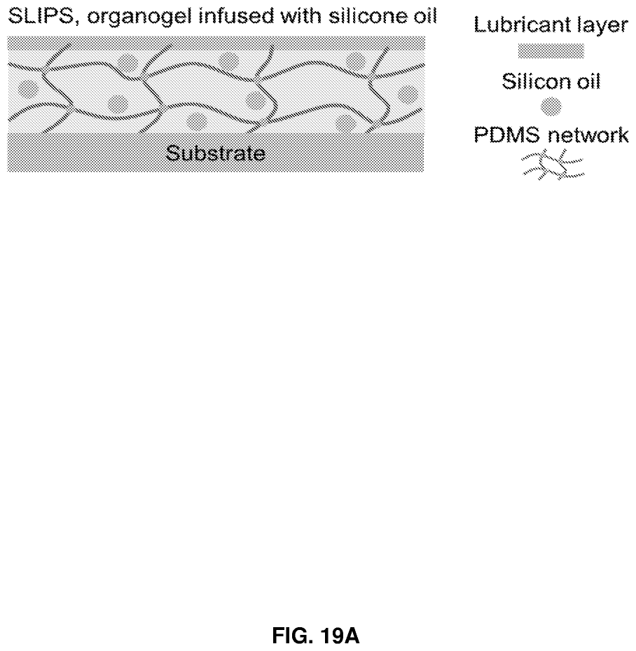

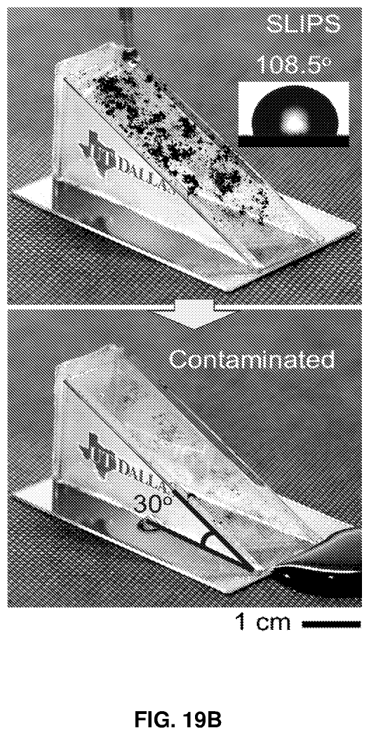

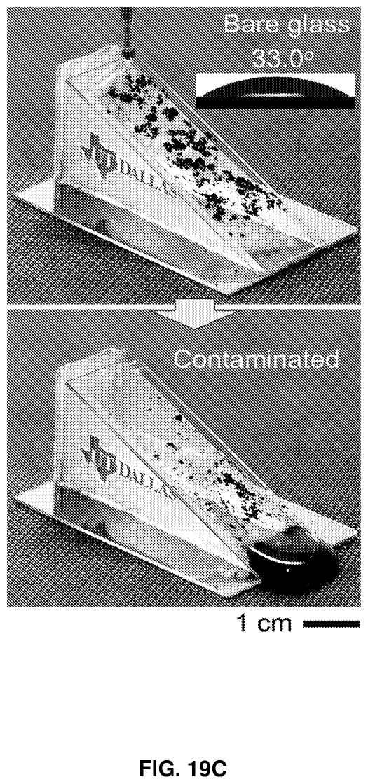

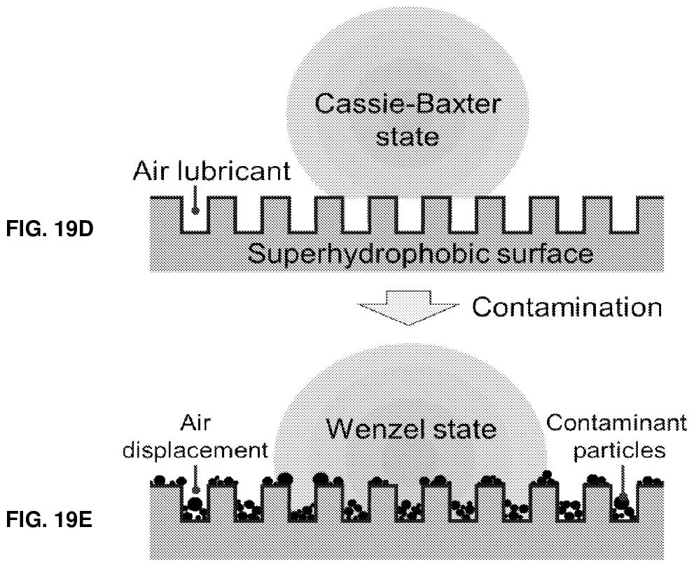

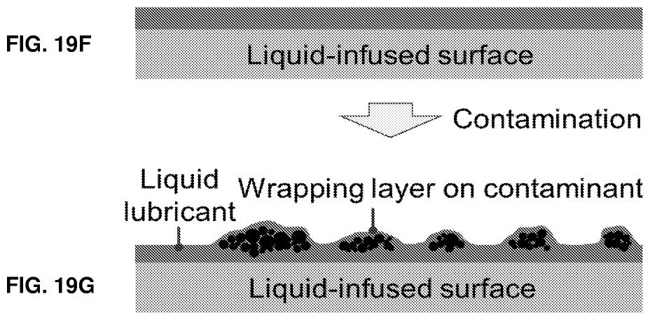

FIG. 19A presents a schematic representation of the structure of transparent SLIPS made by spin coating of organogel on a glass slide and then infused with silicone oil;

FIG. 19B presents photographs illustrating self-cleaning ability of iron oxide particles on SLIPS on glass, with a water CA of 108.5° and the substrate tilted at 30°;

FIG. 19C presents photographs illustrating self-cleaning ability of iron oxide particles on bear glass, with a water CA of 33.0° and the substrate tilted at 30°;

FIG. 19D presents a schematic representation of a scheme for a superhydrophobic surface before contamination by pollutants particles;

FIG. 19E presents a schematic representation of the scheme for the superhydrophobic surface after contamination, in which pollutants particles get into the microstructure on surface inducing the loss of air lubricant

FIG. 19F presents a schematic representation of a scheme for a liquid-infused surface before contamination;

FIG. 19G presents a schematic representation of a scheme for a liquid-infused surface after contamination, in which a liquid wrapping layer forms on contaminants;

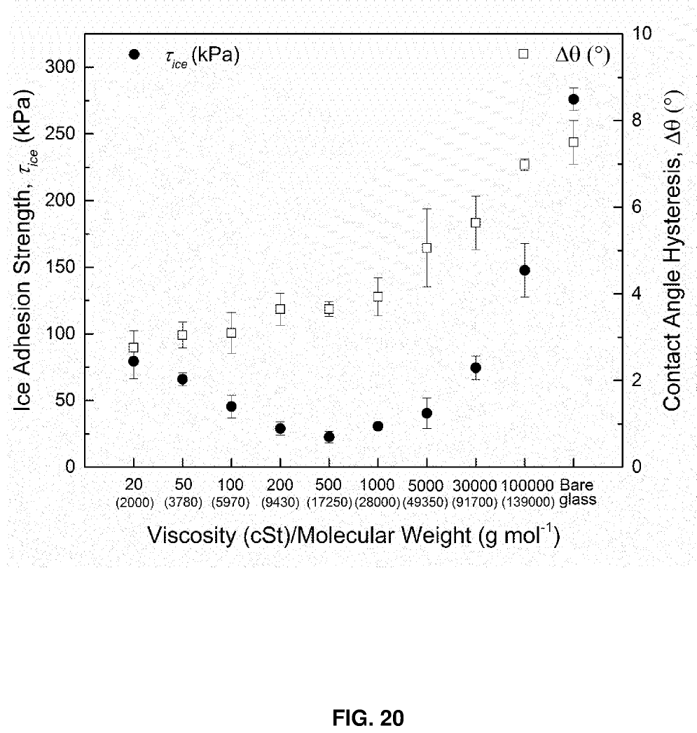

FIG. 20 shows the relationship between ice adhesion strength, water CAH, PDMS oligomer molecular weight and viscosity for SLS grafted on example glass substrate embodiments of the disclosure;

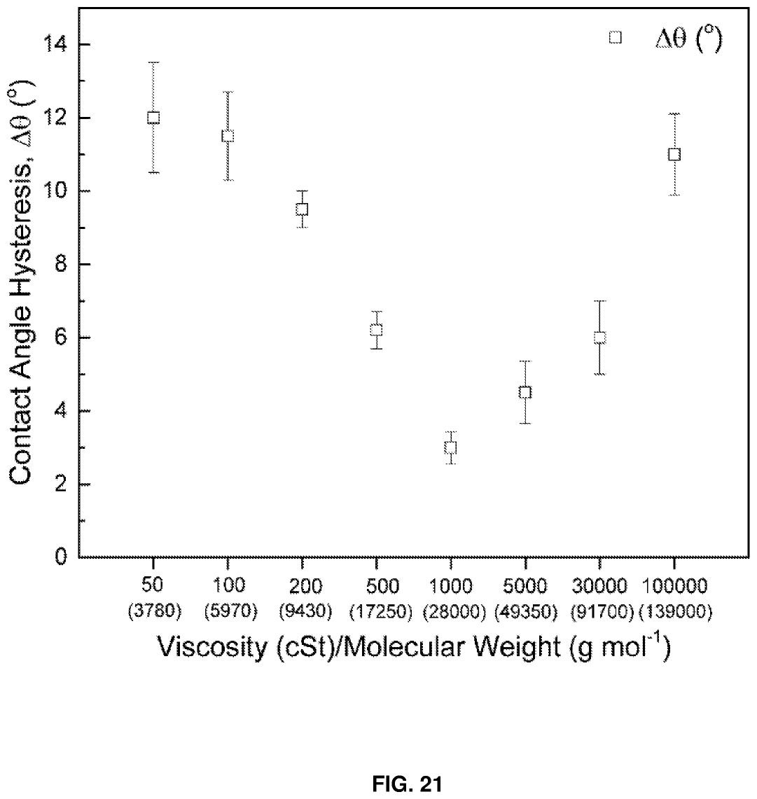

FIG. 21 shows the relationship between water CAH, PDMS oligomer molecular weight and viscosity for SLS grafted on example Aluminum substrate embodiments of the disclosure; and

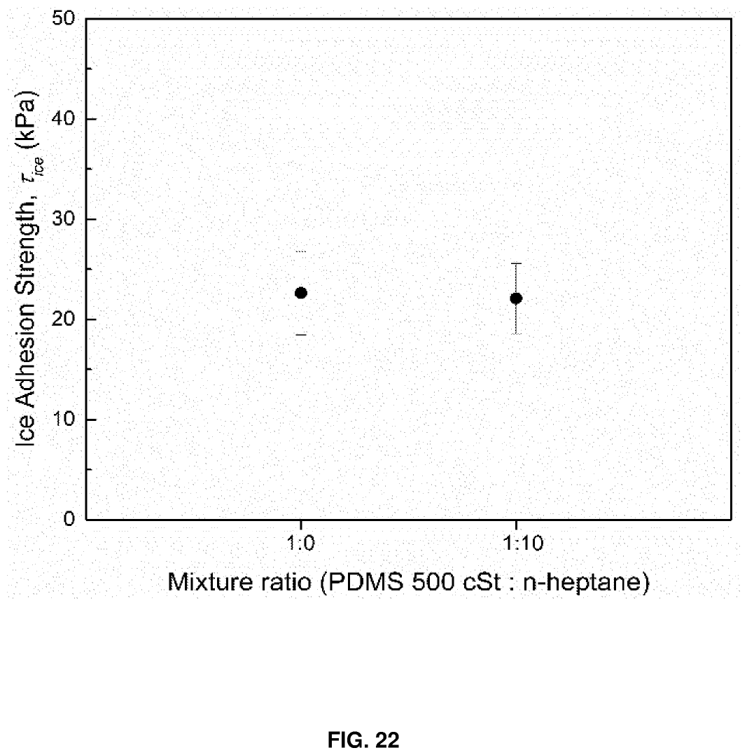

FIG. 22 presents ice adhesion strength of a SLS grafted using a semi-liquid solvent mixtures with different ratios of PDMS and inert liquid on an example glass substrate embodiments of the disclosure.

### DETAILED DESCRIPTION

As part of the present disclosure we have developed a surface treatment that includes the treatment of a substrate surface with certain PDMS oligomers as disclosed herein, with the resulting treated surface having a grafted layer of PDMS polymers covalently bonded thereto. As further disclosed herein, the surface treatment can be applied to a broad range of different types of article substrates and the treated surface can repel a broad range of liquids (e.g., liquids having different surface tensions and polarities). Moreover, as further illustrated herein, at least some embodiments of the treated surfaces can retain their repellence even months after the surface treatment.

We have discovered that ends of the PDMS oligomer of the disclosure can be covalently bonded to a hydroxylated substrate surface in a simple one-step condensation reaction resulting in the PDMS oligomer being covalently tethered to the substrate surface, or covalently tethered to other PDMS oligomers to form a covalently connected chain of such PDMS oligomers, resulting in PDMS polymers covalently tethered to the surface to thereby form the grafted layer.

While not limiting the scope of the disclosure by theory, we believe that our disclosed surface treatment and forming the grafted layer results in a single end of the individual PDMS polymers being covalently bonded to the substrate surface. We further believe that such single-point-connected PDMS polymer molecules have a high degree of rotationally flexibility, which may impart the grafted layer with liquid-like or semi-liquid surface (SLS) like properties which we believe can facilitate liquid repellency.

It was surprising that our surface treatment was effective, given some reports suggesting surface treatments using low molecular weight chlorosilanes (e.g., molecular weight, MW≤about 2 kD) may be ineffective at producing a durable liquid repellant surface, and, other reports suggesting that surface treatments using high molecular weight PDMS polymers (e.g., MW≥about 100 kD) may produce a treated surface with entanglement between the PDMS polymer chains, resulting in a treated surface with limited liquid repellency. Again, while not limiting the scope of the disclosure by theory, we believe that surfaces treated with such low molecular weight chlorosilanes, or, such high molecular weight PDMS polymers, would not likely or reliably result in a grafted layer with semi-liquid surface (SLS) like properties such as disclosed herein.

Nevertheless, some embodiments of the method, and the articles produced therefrom, can result in useful SLS like properties when using PDMS oligomers having a MW of <2 kD (e.g., about 0.5 or about 1 kD) or >100 kD (e.g., up to about 140 kD). For instance, the SLS coverage on the substrate may be incomplete when using PDMS oligomers having a MW of <2 kD. For instance, entanglement may occur when using PDMS oligomers having a MW of >100 kD.

One embodiment of the disclosure is method.

FIG. 1 presents a flow diagram of example method 100 embodiments of the disclosure. With continuing reference to FIG. 1 throughout embodiments of the method 100 can include providing a substrate having a surface, wherein the surface is hydroxylated (step 105). Embodiments of the method can also include exposing the hydroxylated surface of the substrate to a PDMS oligomer (step 110).

Embodiments of the PDMS oligomer having a formula of:

R₁—Si(CH₃)₂—(O—Si(CH₃)₂—)ₙ—O—Si(CH₃)₂—R₂

where at least one of R₁ or R₂ includes: —(CH₂)ₘ—R₃ and R₃ is one of —Cl, —O—(CH₂)ₓH, —SiCl₃, or —Si(O—(CH₂)ₓH)₃, the x is an integer in a range from 0 to 10, the m is an integer in a range from 0 to 10, and the n is an integer in a range from 10 to 500. The R₃ of the PDMS oligomer undergoes hydrolysis such that one terminal Si atom of the PDMS oligomer is covalently bonded (or tethered) to the hydroxylated surface by a condensation reaction to form a grafted layer of PDMS polymers on the surface (step 115). For instance as part of step 115 the PDMS oligomer is covalently bonded to the oxygen atom of the surface, or, a terminal oxygen atom of the PDMS oligomer is covalently bonded to another atom of the substrate, e.g., a Si atom of a silicon substrate.

The R₃ group in the above formula has a functional group and capable of participating in the condensation reaction, and type of functional groups can have a variety of structural formulas depending on the value of x. For instance, when x=0 then R₃ can be one of —Cl, —OH, —SiCl₃, or —Si(OH)₃, when x=1 then R₃ can be one of —Cl, —O—CH₃, —SiCl₃, or —Si(O—CH₃)₃ or when x=2 then R₃ can be one of —Cl, —O—CH₂—CH₃, —SiCl₃, or —Si(O—CH₂—CH₃)₃.

The R₁ or R₂ in the above formula can have a variety of forms depending on the value of m, which sets the length of an optional alkyl chain at the end covalently tethered to the surface and between repeating units of the PDMS oligomers covalently connected to each other in series. For instance, when m=0 then one or both R₁ or R₂ can be —R₃, when m=1 then then one or both R₁ or R₂ can be —(CH₂)₂—R₃, or when m=2 then then one or both R₁ or R₂ can be —(CH₂)₂—R₃, with R₃ having any of the above-described structural formulas.

The value of n sets the chain length of the individual PDMS oligomers by specifying the number repeating dimethylsiloxane units of (O—Si(CH₃)₂—). In some embodiments, when n is less than 10 then even with a plurality of PDMS oligomers covalently connecting to form a chain of PDMS oligomers, the resulting PDMS polymer covalently tethered to the surface may not have the semi-liquid surface (SLS) like properties to facilitate a desired level of liquid repellency. In some embodiments, when n is greater than 500 then adjacent one of the resulting PDMS polymers covalently tethered to the surface may have a length sufficiently long to result in entanglement between adjacent ones of the polymers resulting in a less than desired level of liquid repellency. In some embodiments, it is advantageous for n to be a value in a range from 20 to 100.

When both R₁ or R₂ include the R₃, then a further condensation reaction of the R₃ located at the non-surface tethered end of the PDMS oligomers can occur as part of step 115. That is, the R₃ can be hydrolyzed and a covalent connection to another PDMS oligomer is formed, and so on, to result in a series of covalently-connected chains of PDMS oligomers to result in a PDMS polymer.

In some embodiments, the R₁ and the R₂ can both have same ones of the R₃. For instance, both ends of the PDMS oligomer having the R₁ and the R₂ on either end, can includes a —Cl functional group or a —OH functional group as R₃. In other embodiments, the R₁ and the R₂ can have different ones of R₃. For instance, one end of the PDMS oligomer with the R₁ can have a —Cl functional group as R₃ and the opposite end of the PDMS oligomer with the R₂ can have a —OH functional group as R₃.

When only one R₁ or R₂ include the R₃, then the condensation reaction of the R₃ covalently tethers one end of PDMS oligomers to the surface as part of step 115 but further covalent attachment of additional PDMS oligomers to the surface tethered PDMS oligomer does not occur. For instance, in some embodiments, one of the R₁ or the R₂ has the —(CH₂)ₘ—R₃ and the other one of R₁ or the R₂ includes —(CH₂)ₒCH₃ where o is an integer in a range from 0 to 10. In such embodiments the non-surface tethered end of the PDMS oligomer is terminated with an alkyl group (e.g., the other one of R₁ or the R₂ not tethered to the surface is —CH₃, —(CH₂)₁CH₃—(CH₂)₂CH₃ when o=0, 1 or 2, respectively).

Non-limiting examples of substrates, e.g., provided as part of step 105, include silicon, glass, cross-linked PDMS organogel, plastic, Al, Ti, Fe, Ni or Cr metal substrates or multilayered combinations thereof. For instance, in some embodiments a glass, plastic, silicon or metal substrate can be coated with a layer of Ti and the layer of Ti can be hydroxylated surface.

In some embodiments, exposure of the hydroxylated surface of the substrate to the PDMS oligomer as part of step 110, can be for a period sufficient to allow complete condensation of the all the hydroxyl groups on the surface. For instance, in some embodiments, the exposing (step 110) is for a time period in a range from 5 to 720 minutes, or a range from 10 to 60 minutes. For instance, in some embodiments, for PDMS oligomers of lower molecular weight (e.g., about 0.5 to about 2 kD) the exposing (step 110) can be for a time period of less than 5 minutes. For instance, in some embodiments, using non-surface-treated substrate surfaces the exposing (step 110) can be for a time period in a range from 720 to 1440 minutes.

In some embodiments to facilitate control of the environment under which exposure of the hydroxylated surface of the substrate occurs, the exposing step 110 can occur inside a container holding the substrate therein. For instance, in some such embodiments, the container can be a sealable chamber where the temperature and pressure inside the chamber can be controlled, e.g. to facilitate the completion of the condensation reaction, to maintain the hydroxylated surface until the condensation reaction is completed, to maintain the PDMS oligomer at a desired concentration or phase, or, to facilitate the inclusion of other materials in the container.

For instance, in some such embodiments, the PDMS oligomer in the container can be in a vapor phase.

For instance, in some such embodiments, to control the reaction rate or maintain the PDMS in a vapor phase, the container can be configured to maintain a temperature value in a range from 20 to 100° C., or a range from 40 to 60° C., inside the container.

For instance, in some such embodiments, to maintain low levels water humidity in the container during the ongoing condensation reaction which can generate water as a byproduct and thereby slow or reverse the condensation reaction, the container can be configured to maintain a reduced pressure in a range from 0.1 to 0.9 Torr, or a range from 0.1 to 0.2 Torr, inside the container. For instance, in some embodiments, the water humidity in the container is 20, 10 or 1 percent or less.

For instance, in some such embodiments, the PDMS oligomer in a vapor phase has concentration of about 100 volume percent in the container. However in some embodiments to reduce the concentration of vaporous PDMS oligomer in the container the container can further include gases (e.g., an inert gas).

However, in other embodiments, the PDMS oligomer can be in a liquid phase and the exposing step 110 may not occur inside a container, although in some embodiments a container holding the substrate and liquid phase PDMS oligomer therein could still be used. In some embodiments it can be advantageous for the exposing step 110 to use PDMS oligomer in a liquid phase, e.g., when treating a highly porous or rough substrate surface (e.g., a substrate surface having a surface roughness before forming the grafted layer thereon of greater than 1 nm, or in some embodiments, a surface roughness of at least about 10, 100 or 1000 nm

For instance in some such embodiments where no container is used the liquid phase PDMS oligomer can be deposited (e.g., via spraying) on the substrate surface. In any such embodiments, with or without a container present, it can be advantageous for the liquid phase PDMS oligomer to be maintained a temperature value in a range from 20 to 100° C., or from 40 to 60° C. In any such embodiments, it can be advantageous for the liquid phase PDMS oligomer to have a low water content (e.g., 1 weight % percent or less water in some embodiments). In any such embodiments, the PDMS oligomer in a liquid phase can have a concentration of about 100 volume percent while in some embodiments to reduce the concentration of PDMS oligomer the liquid PDMS oligomer can be mixed with another liquid (e.g., an inert liquid) to form a diluted PDMS oligomer solution.

The inclusion of an inert liquid can advantageously: (1) reduce material cost for PDMS oligomer which general more expensive than the inert liquid, (2) reduce the viscosity, especially when high molecular weight PDMS oligomers are used (e.g., MW=100 kD to 140 kD), and (3) easy to remove via evaporation after applying the liquid phase PDMS. In some embodiments, the inert liquid can be or include ethanol or heptane or similar inert liquids such as other such as other alcohols or hydrocarbons. In some embodiments, the volume percent (vol %) of PDMS can be a value in a range from 100 to 5 vol % and balance the inert liquids.

In some embodiments neither R₁ nor R₂ include the R₃, with —Cl functional group. In such embodiments, acid is not auto-generated as part of the condensation reaction and therefore the condensation reaction does not proceed. In such embodiments, it is advantageous to add an acid to the vaporous or liquid PDMS oligomer. For instance, in some embodiments when the PDMS oligomer is in a container and in a vapor phase it is advantageous to further include an acid vapor in the container (e.g., vaporous hydrochloric acid, sulfuric acid, nitric acid or combinations thereof). For instance, in some embodiments when the PDMS oligomer is in a liquid phase it is advantageous for the liquid PDMS oligomer in include an acid (e.g., hydrochloric acid, sulfuric acid, nitric acid or combinations thereof) to form an acidified PDMS oligomer solution.

As illustrated in FIG. 1, some embodiments of the method 100 can further include forming the hydroxylated surface on the substrate surface (step 120). For instance, in some such embodiments, forming the hydroxylated surface on the substrate surface, can include exposing the substrate surface to an oxygen plasma treatment, a corona treatment, a strong oxidizing solution or a combination thereof. For instance, in some embodiments, exposing the substrate surface to the oxygen plasma treatment can include applying plasma power setting in a range from about 20 to 300 W, or a range from about 190 to 210 W a O₂ pressure in a range from about 50 to 300 mTorr or a range from about 180 to 220 mTorr for a treatment duration in a range from about 0.5 to 30 minutes or a range from about 15 to 25 minutes. For instance, in some embodiments, exposing the substrate surface to the corona treatment can include applying a power setting in a range from about 20 to 300 W and a treatment duration time in a range from about 0.5 to 30 minutes. For instance, in some embodiments, exposing the substrate surface to the strong oxidizing solution can include exposure to a mixture of sulfuric acid and hydrogen peroxide (e.g., a Piranha solution) and an exposure duration time in a range from about 0.5 to 30 minutes.

In other embodiments, however, no additional step of forming the hydroxylated surface on the substrate surface is needed. E.g., there may be no oxygen plasma treatment or other surface treatments applied. E.g., for a substrate surface with an oxide layer thereon (e.g., silicon, glass, metals), hydroxy groups can be inherently or naturally formed in air. It was surprising to us that no surface treatment be required in such cases. However, we found that after a longer reaction time (e.g., step 110 reaction times in a range from 6 hours to 12 hours or 12 to 24 hours), PDMS oligomers (e.g., single-branched PDMS) could be grafted on the surface and the surface showed as good a performance as an SLS formed on a substrate with a plasma surface treatment. Thus, increasing the liquid phase reaction time or reaction temperature can facilitate the grafting of PDMS oligomers per steps 110 and 115 without step 120.

In some embodiments, to further increase liquid repellence, the method can further include adding liquid PDMS molecules on the surface with the grafted layer of PDMS polymers thereon (step 125). Non-limiting examples of such the liquid PDMS molecules include: Cl—Si(CH₃)₂—O—(Si(CH₃)₂O)ₙ—Si(CH₃)₂—Cl (n=10 to 500), OH—Si(CH₃)₂—O—(Si(CH₃)₂O)ₙ—Si(CH₃)₂—OH (n=10 to 500), CH₃O—Si(CH₃)₂—O—(Si(CH₃)₂O)ₙ—Si(CH₃)₂—OCH₃ (n=10 to 500), H(CH₂)₂O—Si(CH₃)₂—O—(Si(CH₃)₂O)ₙ—Si(CH₃)₂—O(CH₂)₂H (n=10 to 200), Cl₃Si—O—Si(CH₃)₂—O—(Si(CH₃)₂O)ₙ—Si(CH₃)₂—O—SiCl₃ (n=10 to 200), (OH)₃Si—O—Si(CH₃)₂—O—(Si(CH₃)₂O)ₙ—Si(CH₃)₂—O—Si(OH)₃ (n=10 to 200), (CH₃O)₃Si—O—Si(CH₃)₂—O—(Si(CH₃)₂O)ₙ—Si(CH₃)₂—O—Si(OCH₃)₃ (n=10 to 200), (H(CH₂)₂O)₃Si—O—Si(CH₃)₂—O—(Si(CH₃)₂O)ₙ—Si(CH₃)₂—O—Si—(O(CH₂)₂H)₃ (n=10 to 200), Cl—Si(CH₃)₂—O—(Si(CH₃)₂O)ₙ—Si(CH₃)₃ (n=10 to 200), OH—Si(CH₃)₂—O—(Si(CH₃)₂O)ₙ—Si(CH₃)₃ (n=10 to 200), CH₃O—Si(CH₃)₂—O—(Si(CH₃)₂O)ₙ—Si(CH₃)₃ (n=10 to 200), H(CH₂)₂O—Si(CH₃)₂—O—(Si(CH₃)₂O)ₙ—Si(CH₃)₃ (n=10 to 200), Cl₃Si—O—Si(CH₃)₂—O—(Si(CH₃)₂O)ₙ—Si(CH₃)₃ (n=10 to 200), (OH)₃Si—O—Si(CH₃)₂—O—(Si(CH₃)₂O)ₙ—Si(CH₃)₃ (n=10 to 200), (CH₃O)₃Si—O—Si(CH₃)₂—O—(Si(CH₃)₂O)ₙ—Si(CH₃)₃ (n=10 to 200), (H(CH₂)₂O)₃Si—O—Si(CH₃)₂—O—(Si(CH₃)₂O)ₙ—Si(CH₃)₃ (n=10 to 200), Cl—Si(CH₃)₂—O—(Si(CH₃)₂O)ₙ—Si(CH₃)₂OH (n=10 to 200), OH—Si(CH₃)₂—O—(Si(CH₃)₂O)ₙ—Si(CH₃)₂OH (n=10 to 200), CH₃O—Si(CH₃)₂—O—(Si(CH₃)₂O)ₙ—Si(CH₃)₂OH (n=10 to 200), H(CH₂)₂O—Si(CH₃)₂—O—(Si(CH₃)₂O)ₙ—Si(CH₃)₂OH (n=10 to 200), Cl₃Si—O—Si(CH₃)₂—O—(Si(CH₃)₂O)ₙ—Si(CH₃)₂OH (n=10 to 200), (OH)₃Si—O—Si(CH₃)₂—O—(Si(CH₃)₂O)ₙ— Si(CH₃)₂OH (n=10 to 200), (CH₃O)₃Si—O—Si(CH₃)₂—O—(Si(CH₃)₂O)ₙ—Si(CH₃)₂OH (n=10 to 200), (H(CH₂)₂O)₃Si—O—Si(CH₃)₂—O—(Si(CH₃)₂O)ₙ—Si(CH₃)₂OH (n=10 to 200), ClSi(CH₃)₂—(CH₂)₂—(Si(CH₃)₂O)ₙ—Si(CH₃)₂OH (n=10 to 200), OHSi(CH₃)₂—(CH₂)₂—(Si(CH₃)₂O)ₙ—Si(CH₃)₂OH (n=10 to 200), CH₃OSi(CH₃)₂—(CH₂)₂—(Si(CH₃)₂O)ₙ—Si(CH₃)₂OH (n=10 to 200), H(CH₂)₂OSi(CH₃)₂—(CH₂)₂—(Si(CH₃)₂O)ₙ—Si(CH₃)₂OH (n=10 to 200), Cl₃Si—(CH₂)₂—Si(CH₃)₂—O—(Si(CH₃)₂O)ₙ—Si(CH₃)₂OH (n=10 to 200), (OH)₃Si—(CH₂)₂—Si(CH₃)₂—O—(Si(CH₃)₂O)ₙ—Si(CH₃)₂OH (n=10 to 200), (CH₃O)₃Si—(CH₂)₂—Si(CH₃)₂—O—(Si(CH₃)₂O)ₙ—Si(CH₃)₂OH (n=10 to 200), (H(CH₂)₂O)₃Si—(CH₂)₂—Si(CH₃)₂—O—(Si(CH₃)₂O)ₙ—Si(CH₃)₂OH (n=10 to 200), ClSi(CH₃)₂—(CH₂)₂—(Si(CH₃)₂O)ₙ—Si(CH₃)₂OH (n=10 to 200), OHSi(CH₃)₂—(CH₂)₂—(Si(CH₃)₂O)ₙ—Si(CH₃)₂OH (n=10 to 200), CH₃OSi(CH₃)₂—(CH₂)₂—(Si(CH₃)₂O)ₙ—Si(CH₃)₂OH (n=10 to 200), H(CH₂)₂OSi(CH₃)₂—(CH₂)₂—(Si(CH₃)₂O)ₙ—Si(CH₃)₂OH (n=10 to 200), Cl₃Si—(CH₂)₂—Si(CH₃)₂—O—(Si(CH₃)₂O)ₙ—Si(CH₃)₂OH (n=10 to 200), (OH)₃Si—(CH₂)₂—Si(CH₃)₂—O—(Si(CH₃)₂O)ₙ—Si(CH₃)₂OH (n=10 to 200), (CH₃O)₃Si—(CH₂)₂—Si(CH₃)₂—O—(Si(CH₃)₂O)ₙ—Si(CH₃)₂OH (n=10 to 200), (H(CH₂)₂O)₃Si— (CH₂)₂—Si(CH₃)₂—O—(Si(CH₃)₂O)ₙ—Si(CH₃)₂OH (n=10 to 200), or mixtures thereof.

In some embodiments, after the hydrolysis step 115, the method further includes a step 130 of rinsing off the PDMS oligomers that are not grafted to the surface. E.g., as part of step 130, the free PDMS oligomers can be sprayed with, or soaked in a bath of, toluene, acetone or combination thereof. In other embodiments, however, some or all of the unreacted free PDMS oligomers can be left on the surface, e.g., to further increase liquid or ice repellence, in addition to, or as an alternative to, the adding liquid PDMS molecules on the surface in step 125.

Another embodiment of the disclosure is an article. FIG. 2 presents a schematic representation of an embodiment of an article 200 of the disclosure. With continuing reference to FIG. 2 throughout, embodiments of article include a substrate having a surface (e.g., substrate 205, surface 210) with a grafted layer of PDMS polymers thereon (e.g., grafted layer 215, PDMS polymers 220). Each of the PDMS polymers have a formula of:

Q₁-Si(CH₃)₂—(O—Si(CH₃)₂—)ₙ—O—Si(CH₃)₂-Q₂

where Q₁ is one of: —O— or —O—(CH₂)ₘ—O—, Q₂ is -(-Q₁-Si(CH₃)₂—(O—Si(CH₃)₂—)ₙ—O—Si(CH₃)₂-)ₚ-Q₃, Q₃ is one of —OH, —(CH₂)ₘ—OH, —Si(OH)₃, or —(CH₂)ₘ—Si(OH)₃, m is an integer in a range from 0 to 10, n is an integer in a range from 0 to 500, and p is an integer in a range from 0 to 500 and the Q₁ is an end (e.g., tethered end 225) of the PDMS polymer covalently bonded or tethered to the surface.

The m and n are analogous to that described above. Q₂ includes the additional repeating units (p) of PDMS oligomers that are covalently attached to the PDMS oligomer covalently tethered to surface and to each other in series and Q₃ is untethered opposite end (e.g., untethered end 230) of the PDMS polymer. For instance, when p=0 there are no additional repeating PDMS oligomer units and the PDMS polymer is Q₁-Si(CH₃)₂—(O—Si(CH₃)₂—)ₙ—O—Si(CH₃)₂-Q₃, when p=1 there is one additional PDMS oligomer repeating unit and the PDMS polymer is Q₁-Si(CH₃)₂—(O—Si(CH₃)₂—)ₙ—O—Si(CH₃)₂-(-Q₁-Si(CH₃)₂—(O—Si(CH₃)₂—)ₙ—O—Si(CH₃)₂—)-Q₃, when p=2 there is two additional PDMS oligomer repeating units and the PDMS polymer is Q₁-Si(CH₃)₂—(O—Si(CH₃)₂—)ₙ—O—Si(CH₃)₂-(-Q₁-Si(CH₃)₂—(O—Si(CH₃)₂—)ₙ—O—Si(CH₃)₂—)₂-Q₃.

In some embodiments of the article, the grafted layer of PDMS polymers has an average thickness (e.g., thickness 235) in a range from about 10 to 40 nm, and in some embodiment, a range from 25 to 35 nm.

In some embodiments of the article, the surface with the grafted layer of PDMS polymers thereon has a surface roughness of 1 nm or less.

In some embodiments of the article, the grafted layer of PDMS polymers is a liquid repellant surface. For instance, in some embodiments, a droplet of water on the surface with the grafted layer of PDMS polymers thereon has a contact angle hysteresis in a range from 0 to 5 degrees and in some embodiments a range from 0.5 to 1.5 degrees.

In some embodiments of the article, the article can further include liquid PDMS molecules (e.q., liquid PDMS 240) on the surface with the grafted layer of PDMS polymers thereon including any of the liquid PDMS molecules disclosed in the context of step 125.

As illustrated in FIG. 2, the PDMS polymer chains can have a brush-like structural appearance of the substrate, with the individually attached PDMS polymer molecules covalently attached to the surface (e.g., at tethered end 225). While not limiting the scope of the disclosure by theoretical considerations, we believe that such PDMS chains in the semi-liquid coating thus have no, or at least reduced, physical entanglement and/or chemical cross-linking between each other. Consequently, the PDMS molecular chains can maintain their high dynamic flexibility which facilitates providing a liquid-like lubrication. Thus, the SLS coating can show better repellency to liquids including water, organic liquids and oils than a solid cross-linked PDMS coating, and lower ice adhesion strength, as compared to such solid cross-linked PDMS coating.

In any such embodiments of the article, the surface with the grafted layer of PDMS polymers thereon can be part of a surface of a: pipeline, a land air or water-born vehicle, a window, a window cleaning blade, a wind turbine blade, a heat transfer device or an article of clothing (e.g., a shoe, jacket or hat).

Embodiments of the method and article are disclosed herein in the context of the substrate surface being exposed to a single chemical formula type of the PDMS oligomer to form a grafted layer of a single chemical formula type of PDMS polymer on the surface. However, any embodiments of the method and article could include exposing the substrate surface to a multiple different chemical formula types of the PDMS oligomer to form a grafted layer having multiple different chemical formula types of PDMS polymers on the surface.

### Experimental Results

Example method and article embodiments of the disclosure are presented to demonstrate our one-step condensation reaction method to form durable omniphobic grafted layers, e.g., having semi-liquid surface(s) (SLS). As disclosed herein such a grafted layer and surface can be made by tethering one end of the liquid polymer chains of polydimethylsiloxane (PDMS) oligomers on a solid substrate but keep the other end mobile. The molecularly patterned mobile polymer chains completely cover the solid substrate. Unlike the physical retention of lubricant on liquid infused surfaces, the mobile polymer chains are chemically bonded on the solid surfaces to form an SLS. The solid-tethered PDMS polymer can maintain high molecular mobility due to their unentangled polymer dynamics and extremely low glass transition temperature (T_{g}=−125° C.).^{[28]} Although the tethered liquid polymer cannot behave like a real liquid, the unentangled polymer brushes with mobile molecular chains on one end still show liquid-like lubrication in terms of droplet repellency.^{[42]} Such a semi-liquid surface does not rely on solid textures to retain air or liquid lubricant to repel water and low surface tension fluids. Instead, the chemically bonded mobile molecular chains can maintain the lubrication in harsh environments for long-term operations. We show that the liquid repellency of the SLS remains excellent after heating at 105° C. for more than three months, 1000 cycles of abrasion and adhesion tests, and scratch test. Moreover, the SLS can be created on various plasma-treated substrates covered with an oxide layer, such as silicon, glass and metals (e.g., Ti, Fe, Ni, Cr, and Al) while maintaining the optical transparency. We demonstrate that our SLS outperforms other types of liquid repellent surfaces such as liquid infused surfaces and superhydrophobic surfaces (SHS) in terms of durability, fog harvesting, self-cleaning and the repellency of complex fluids (e.g. urine) and extremely low surface tension fluids (e.g., FC72 and Krytox101).

We disclose certain embodiments of our method which do not require solvent, catalyst or specific condition to make the SLS. As shown in FIG. 3A, chlorine-terminated PDMS (Cl-PDMS-Cl) oligomer with the viscosity of 20-50 cSt (Gelest Inc., molecular weight is 2000-4000) was used in the vapor phase grafting process. Simultaneous hydrolysis and polycondensation occurred in this one-step surface grafting. Briefly, Cl-PDMS-Cl was spontaneously hydrolyzed to form hydroxyl-terminated PDMS (OH-PDMS-OH) when moisture existed due to its high reactivity toward nucleophiles of water molecules. Then, the covalent grafting and reactive growth of the PDMS polymer chain could rapidly proceed via the self-catalyzed polycondensation by hydrochloric acid generated from the hydrolysis of Cl-PDMS-Cl.^{[43]} Herein, Cl-PDMS-Cl oligomer was selected for grafting modification because the molecule contains reactive chlorine group on two ends. Therefore, the length of PDMS polymer can rapidly grow from the PDMS oligomers being covalently connected in series. Moreover, the PDMS polymer is highly flexible which has a mobile chain owing to its low rotation barrier of repeated Si—O—Si bond (bond angle=143°).^{[28]} The grafted flexible PDMS polymer, with one end mobile and the other end tethered, behaved like a semi-liquid, could maintain its high mobility through rotational and/or bending motions.^{[33]} Its high molecular mobility enabled the SLS an unprecedented liquid repellency for both water and organic liquids compared to reported works (FIG. 3B, and Table S1).

Various reaction systems (with or without additives of solvents and catalysts) and multiple reaction conditions were studied to obtain preparation parameters for SLS (Tables S2, S3).

We demonstrated that the use of Cl-PDMS-Cl either in the vapor phase or in the liquid phase under reduced pressure could lead to the optimal performance for SLS. In this work, all the semi-liquid surfaces were prepared by vapor phase in a vacuum oven at 60° C. for 60 min unless otherwise specified (FIG. 8). The atomic force microscope (AFM) images show that the SLS has a decreased roughness (0.35 nm) when compared to a surface coated with small molecule of chlorotrimethylsilane (Me₃SiCl) (2.26 nm) or a bare glass surface (2.72 nm) (FIGS. 3C, 3D, and FIGS. 9A-9C). The sub-nanometer roughness of the SLS indicates that the flexible PDMS polymer grafted semi-liquid surface has an extremely smooth surface. Such a liquid-like SLS can repel both low and high surface tension liquids (liquid surface tension, γ), such as water (γ=72.8 mN m⁻¹), and even for the fluorocarbon liquids of Krytox101 (γ=17 mN m⁻¹) and FC72 (γ=10 mN m⁻¹) (FIG. 3E, Table S4).

Only Krytox101 is shown in FIG. 3E due to the fast evaporation of FC72. While the repellency of SLS to FC72 is demonstrated by magnified side-view which was taken by the camera mounted on goniometer. Various liquid droplets showed extremely low contact angle hysteresis (CAH Δθ≤1.0°, Table S4). CAH Δθ is the difference between advancing (θ_{adv}) and receding (θ_{rec}) contact angles (Δθ=θ_{adv}−θ_{rec}). A small CAH Δθ of a liquid droplet indicates a good liquid repellency on the SLS. Furthermore, the SLS is highly thermostable due to the strong bond dissociation energy of Si—O (444 kJ/mol) between PDMS molecules and the substrate.^{[28]} The SLS still showed an ultralow CAH (Δθ≤1.5°) for water even after heating at 105° C. for more than 3 months, while the SLIPS lost water repellency after only 3 min due to the strong lubricant evaporation at such a high temperature (FIG. 3F). In addition, PDMS has inherent optical transparency. The SLS shows identical optical transparency compared with a bare glass substrate (FIG. 3G). This liquid repellent polymer coating will not influence the light transmission of the substrate. Although both SLS and SLIPS show outstanding liquid repellency and optical transparency, the liquid-like polymers are chemically bonded on SLS, while the liquid lubricant is physically retained on SLIPS. The lubrication of SLS remains in harsh conditions (e.g., high temperature), outperforming SLIPS in durable operations.

The chemical composition of SLS was analyzed by attenuated total reflection Fourier transform infrared spectroscopy (ATR-FTIR). As shown in FIG. 4A, the characteristic peaks at 2965 cm⁻¹ (ν C—H), 1261 cm⁻¹ (ν Si—CH₃), 1039/1097 cm⁻¹ (ν Si—O—Si), 806 cm⁻¹ (ν Si—(CH₃)₂) on SLS indicates a successfully grafting of PDMS polymer.^{[44-45]} Compared with bare and plasma-treated silicon, the SLS displays enhanced absorption peaks at 3725 cm⁻¹ and 3000-3650 cm⁻¹, which correspond to the vibrations of Si—OH and O—H of adsorbed water molecules (Inset in FIG. 4A).^{[44-45]} The PDMS polymers on SLS are terminated with hydroxyl groups as demonstrated in FIG. 2, which could be helpful for the rapid nucleation of water molecules.^{[5]} The scanning electron microscope (SEM) image also confirms the grafted PDMS layer on SLS with a thickness of around 30 nm (FIG. 4B and FIGS. 9A-9C). To better understand the kinetics of PDMS grafting, we studied the effects of reaction temperature and reaction time on the wetting and mobility of liquid droplets on SLS. All the semi-liquid surfaces were made on silicon by vapor phase grafting in a vacuum oven. The CAH and sliding angle (SA) of water droplets on SLS shows a sharp decline when the coating temperature increases to around 50° C. for 60 min (FIG. 4C, and FIG. 10A). Specifically, the SLS with coating temperatures below 50° C. shows a large CAH (Δθ>12°) and SA (>58°) for water. When the coating temperature increases beyond 60° C., an ultralow water CAH (Δθ=1.0°) and SA (=4°) are obtained (FIG. 4C, and FIG. 10A). The reason is that a thicker and denser PDMS polymer (thickness=30.1 nm) can be grafted at 60° C. than that of 4.8 nm at 20° C. (FIG. 4D). A thinner PDMS coating at 20° C. indicates a less dense PDMS layer. The elevated temperature enables remarkably enhanced evaporation of liquid Cl-PDMS-Cl, thus inducing a high interfacial concentration of reactant, and rapid hydrolysis and polycondensation (FIG. 11). Therefore, preparing the samples at a higher temperature (T=60° C.) can significantly increase the formation rate and thickness of PDMS coating, resulting in an improved liquid repellency on SLS. Interestingly, all the SLS grafted within 10 min to 720 min exhibit an ultralow CAH (Δθ<1.8°), and the thickness of PDMS coating only slightly increases from 28.8 to 33.3 nm at 60° C. (FIGS. 4E, 4F). It indicates that the equilibrium for the growth of PDMS polymer in this work could be rapidly established in 10 min at 60° C. After that, the polycondensation rate of PDMS on the surface is significantly inhibited by the accumulation of absorbed water that is generated from the reaction, even though reduced pressure is applied. A slight increase of SA from 4° to 6.5° was observed on SLS with duration increased from 180 to 720 min demonstrating a less homogeneity of PDMS coating for longer coating time (FIG. 4F and FIG. 10B).^{[31]} Overall, the ultralow CAH (Δθ=1.0°) of water droplets on SLS at 60° C. for 60 min illustrates the high mobility and non-entanglement of the grafted PDMS polymer with a thickness of 30 nm.

The non-defect and homogeneity of the polymer coating are thought to be important for minimizing CAH.^{[33,37]} In particular, our method can form a 28.8 nm PDMS coating within 10 min with the chlorine-terminated PDMS (Cl-PDMS-Cl) oligomer as the reactive segment, while only a few nanometers (less than 5 nm) could be given in previous works using small molecular weight chlorosilanes for surface modifications (e.g., (Me₃SiO)₃SiCH₂CH₂Si(Me)₂Cl, Cl(Me₂SiO)˜SiMe₂Cl, where n=1-3).^{[27,35,46]} In consequence, much better coverage of PDMS polymer on the SLS could be achieved by using our vapor phase grafting. We show that all the PDMS-grafted semi-liquid surfaces present water CAs of ˜105° and negligible deviations for five independent measurements at different positions, indicating the chemical homogeneity on these SLS (FIG. 5A and FIGS. 12A-12G). Moreover, the SLS made on different substrates show a small CAH to toluene which has a low surface tension of 28.4 mN m⁻¹ (FIG. 5B). The superior omniphobicity of SLS with ultralow CAH and SA is applicable to a broad range of polar or nonpolar liquids that span surface tensions from 72.8 to 10 mN m⁻¹ (FIG. 5C). Particularly, most of the organic liquids (e.g., toluene, hexadecane, acetone, Krytox101, and FC72) start to slide off on the SLS at a tilted angle less than 0.6° (Table S4). A high sliding velocity of 19.9 mm s⁻¹ of acetone (˜5 μL) is achieved at a tilted angle of 10° (FIGS. 13A-13B). The SLS on the metal substrates can also repel organic liquids and water (FIG. 5B and FIG. 14). At elevated temperature, the viscosity of the PDMS polymer grafted on the semi-liquid surface can be significantly reduced. Thus, the sliding behaviors of liquid droplets are significantly enhanced via heating of the substrate. When the temperature is increased from 20 to 80° C., the sliding velocity of the droplet increases from 0.24 to 1.68 mm s⁻¹, where a 5 μL hexadecane droplet is applied at a tilted angle of 3° (FIG. 5D and FIGS. 15A-15B). The increased sliding velocity is also observed on SLIPS (anodic aluminum oxide (AAO) substrate infused with Krytox101) at elevated temperature. Here, hexadecane was used for demonstration because it has a high boiling temperature (287° C.). It indicates that the decreased viscosity of the grafted semi-liquid polymers can significantly enhance the molecular mobility and reduce the relaxation time for the tethered PDMS molecular chains, resulting in improved liquid repellency.^{[30,47]} While the droplet was pinned on the SLIPS after heating up to 110° C. due to the rapid evaporation of lubricant of Krytox101. FIG. 5E shows the time-sequence images of the sliding of the droplet of FC72 which has a ultralow surface tension of 10 mN m⁻¹. Moreover, the repellency of complex fluids was studied to show the broad impacts of the newly developed surface. The SLS on silicon and aluminum can easily repel crude oil, mineral oil, and urine (FIGS. 5E-5G). In contrast, all these liquids spread on the bare substrates, leaving large wetted footprints. The SLS enabled repellency of crude oil on metals is important for petroleum applications, while the non-sticky surface for mineral oil is important in kitchens. The rapid removal of urine is highly desirable to save water in toilets, as well as potential biomedical applications.

The SLS has the potential to address the long-standing durability issue of liquid repellent surfaces. Superomniphobic surfaces or liquid infused surfaces rely on topographic textures to lock air or liquid lubricant for repelling water and oil. However, high temperature, abrasion, and scratching can lead to lubricant loss or structural damage. Herein, comprehensive durability tests under harsh conditions, such as high temperature, abrasion, adhesion, and scratching were carried out to demonstrate the durable liquid repellency of water and oil on SLS (FIGS. 6A-6G, and FIGS. 16A-16C and 17A-17B). SLIPS made from Krytox101-infused black silicon was tested as a comparison. First, heating usually leads to the failure of liquid repellency owing to lubricant loss. After continuously heating at 105° C. on a hotplate for more than 3 months, the SLS showed unchanged liquid repellency to water and hexadecane (FIGS. 16A-16C), while SLIPS lost the liquid repellency after 3 min due to the partial lubricant evaporation. Second, abrasion can often easily damage surface nanotextures. After adding a 200 g load in the abrasion test, the SLIPS lost liquid repellency after 10 cycles, while the SLS can still repel water and hexadecane after 1000 cycles (FIGS. 6A, 6C, 6E, FIGS. 17A-17B). Third, reducing adhesion is thought to be important for both liquid and solid on a surface. Liquid infused surfaces could reduce the adhesion as well, but they lost liquid repellency after around 200 cycles due to the damage of surface textures and the loss of lubricant (FIGS. 17A-17B). The SLS can reduce adhesion after 1000 cycle and the liquid repellency remains (FIGS. 6B, 6D, 6F). Fourth, scratching can also lead to failure of liquid repellent surfaces. The physical scratching enables an increasing contact line pinning on the surface thus leading large CAH.^{[33]} However, both water and oil droplets can slide off the scratched SLS which results from the densely coated semi-liquid polymer layer on the surface (FIG. 6G). The unprecedented durability of the SLS will undoubtedly broaden the possibility for broader engineering applications than existing liquid repellent surfaces.

Such a durable SLS with non-sticky performance to various liquids is significant for engineering applications. Here, we show two application examples in long-term fog harvesting and self-cleaning. As hydrophobic surfaces (HPS) and liquid infused surfaces have been extensively studied in fog harvesting, we compared the SLS (made on silicon) with SLIPS (mineral oil infused black silicon), and an HPS (PTFE-coated silicon) in fog harvesting (FIG. 7A). The mineral oil, instead of Krytox101, was used as a lubricant for the fabrication of SLIPS because it has a better performance for water harvesting.^{[48]} The contact angles of water droplets on HPS, SLS, and SLIPS are 108.8°, 106.0°, and 103.6°, respectively. This indicates their static wetting behaviors are close to each other. However, the water CAH on those surfaces are 18.6°, 1.0° and 1.1°, respectively (FIG. 18). We first tested the fog harvesting continuously at 4 h. The SLS performed comparably to SLIPS, while the HPS could not harvest water as efficiently due to the large CAH (FIG. 7C). More importantly, after 4 h, the fog harvesting performance on SLS remained as good as the beginning, but on SLIPS most of the captured water droplets were pinned on the surface due to the depletion of liquid lubricant (FIG. 7C). This clearly showed the durability of our SLS in long-term fog harvesting applications. To quantify the fog harvesting rates on three surfaces, we compared the fog harvesting rate in 0-20 min and that in 240-260 min (FIG. 7D). The SLS still exhibited efficient fog harvesting rate of 11.07 kg h⁻¹ m⁻² after 4 h which is near to that of 11.22 kg h⁻¹ m⁻² in the first 20 min (FIG. 7D). There is a negligible change of water CA (from 106.0° to 105.9°) and CAH (from 1.0° to 1.2°) on SLS showing high stability for long term water harvesting (Insets in FIG. 7D and FIG. 18). However, for SLIPS, its fog harvesting rate decreased from 10.61 to 2.05 kg h⁻¹ m⁻² by 81% (FIG. 7D). The increased water CA from 103.6° to 149.7° illustrated the ability loss of SLIPS due to the lubricant displacement along with the moving droplets (Insets in FIG. 7D). Meanwhile, the water CAH on SLIPS increased largely from 1.1° to 38.6° after long term fog harvesting indicating a great lateral adhesion force (F_{LA}) to droplets on the surface (FIG. 18). Because CAH is the key criterion for reflecting the F_{LA} of the droplets on surfaces, as described by the Furmidge's relation in Equation (1),^{[49]}

$${F}_{LA} = 2 αγ ( cos {θ}_{rec} \cdot cos {θ}_{adc} ) \qquad ( 1 )$$

Where α is the base contact radius of the droplet with the surface, γ is the liquid surface tension. As shown, the lower the CAH, the easier for the removal of droplets from the surface (smaller F_{LA}), the better the sliding for liquid repellency. As a comparison, the fog harvesting rate of the HPS (PTFE-coated surface, 5.4 kg h⁻¹ m⁻²) in the first 20 min is ˜53% lower than that of SLS indicating a comparatively slower rate for water absorption (FIG. 7D). Furthermore, we studied the droplet dynamics on those three surfaces (FIG. 7E). The gravity-driven shedding characteristics of different surfaces were quantified by the average shedding radius/frequency^{[50]} (statistical data derived from the first 20 min before the evident lubricant loss for SLIPS for fog harvesting, FIG. 7E). In the first 20 min, both SLS and SLIPS presented low pinning to water droplets displaying small shedding radius of 0.61 mm and 0.52 mm because of low water CAH, respectively (FIG. 7B, FIG. 18). While SLS showed a higher shedding frequency of 0.42 s⁻¹ than that of SLIPS of 0.24 s⁻¹, which indicated a much higher efficiency for water absorption (FIG. 7E). As a HPS for comparison, PTFE-coated surface with a water CA of 108.8° and CAH of 18.6°, displayed a large shedding radius of 1.82 mm and an extremely small shedding frequency of 0.007 s⁻¹ caused by a great lateral adhesion force (i.e., large CAH, FIG. 7E and FIG. 18) on the surface.

Self-cleaning, transparent and liquid repellent surfaces are highly desired for solar panels, buildings, and cars, et al. Therefore, we compared the self-cleaning performances of the SLS, SHS, SLIPS, and bare glass. These four surfaces showed water contact angles of 104.9°, 152.3°, 108.5°, 33.0°, respectively (FIGS. 7F, 7G, and FIGS. 19A-19G). Herein, the iron oxide powder with a particle size less than 5 μm which contained nanosized particles was used as “contaminant”. On SLS, there is no physical structure and the surface is tethered with liquid-like flexible PDMS polymers. The particles hardly get into the dense polymer layer on SLS, so water droplets could slide off and completely clean the surface by taking away the particulate contaminants without leaving any dust (FIG. 7F). However, contamination occurred on the SHS, SLIPS, and bare glass (FIG. 7G and FIGS. 19A-19G). The small contaminant particles are able to get into the micro/nanostructures when the size of the contaminant is smaller than the gap of the structures on SHS. The deposited contaminant changes the surface chemistry, resulting in the displacement of air lubricant and the failure of self-cleaning (FIGS. 19A-19G). Meanwhile, the loss of the air lubricant will eventually induce a wettability transition from the Cassie-Baxter state to the Wenzel state on SHS. On SLIPS, viscous liquid lubricants are used to physically impregnate the surface structures, so the small contaminant particles are wrapped by the liquid lubricant. This makes it hard to clean the surfaces (FIGS. 19A-19G). Moreover, the wrapping layer on contaminants will accelerate the loss of lubricant on SLIPS and induce the failure of self-cleaning. Water wetted the bare glass and was not able to self-clean the surface due to its hydrophilicity. Therefore, we demonstrated that the SLS outperforms the current state-of-art techniques in both fog harvesting and self-cleaning applications.

In summary, we have successfully developed a one-step and robust strategy to fabricate a transparent SLS for durable liquid repellency. The tethered flexible PDMS polymer with a thickness of 30 nm present superior liquid-like lubrications at liquid-solid interface. The newly developed SLS can unprecedentedly repel liquids in a broad range of surface tensions from 72.8 to 10 mN m⁻¹, such as water, ultralow surface tension liquids (e.g., FC72 and Krytox101), and complex fluids (e.g., crude oil and urine). More importantly, the SLS exhibits impressive durability in liquid repellency compared to the state-of-the-art liquid repellent surfaces, such as liquid infused surfaces and superhydrophobic surfaces, under long-term fog harvesting, self-cleaning, heating, abrasion and adhesion tests. We have also demonstrated that the SLS can be made on various substrates with optical transparency, such as silicon, glass, and metals. While our work used grafted PDMS as an example, in principle, any liquid-like amorphous polymer with highly mobile chains is able to form such an SLS. The SLS enabled repellency of crude oil can reduce drag for petroleum transportation, the non-sticky property for mineral oil can mitigate contamination in kitchens and the rapid removal of urine is highly desirable to save clean water for toilets. In addition to the demonstrations in this work, we envision that the SLS may pave a way for potential applications, such as drag reduction, anti-fouling, anti-icing, dropwise condensation, and water harvesting.

FIGS. 3A-3G. Multifunctional semi-liquid surfaces (SLS) with durable liquid repellency. FIG. 3A: One-step self-catalyzed grafting of chlorine-terminated PDMS polymer (20-50 cSt, molecular weight is 2000-4000) on a hydroxylated substrate. FIG. 3B: Schematic of droplet sliding on a tilted SLS. FIGS. 3C AND 3D: 3D AFM images of a glass surface coated with small molecular chlorosilane (FIG. 3C) and SLS on glass grafted with flexible PDMS polymer (FIG. 3D). FIG. 3E: Time-sequence images of liquid repellency of 2 μL Krytox101 (γ=17 mN m⁻¹) and 20 μL water (γ=72.8 mN m⁻¹) on SLS with glass substrate and bare glass at a tilted angle of 10°. FIG. 3F: Comparison of water CAH as a function of heating time at 105° C. on SLS with the silicon substrate and SLIPS made by black silicon infused with Krytox101. The insets show that 5 μL water droplet is pinned on SLIPS after 3 min due to lubricant evaporation but it remains mobile on SLS after more than 3 months. FIG. 3G: UV/Vis spectra of SLS on glass and bare glass, showing the optical transparency of SLS.

FIGS. 4A-4F. Chemical composition and synthesis optimization of grafted PDMS polymer for the fabrication of SLS. FIG. 4A: ATR-FTIR spectra, and FIG. 4B: SEM image of a cross-sectional view of SLS on silicon (grafting time: 60 min, and grafting temperature: 60° C.). FIG. 4C: θ_{adv}, θ_{rec} and CAH of water droplets on SLS, and (FIG. 4D) the corresponding PDMS thickness measured by an ellipsometer. The grafting time is 60 min. (FIG. 4E) θ_{adv}, θ_{rec} and CAH of water droplets on SLS, and (FIG. 4F) the corresponding PDMS thickness measured by an ellipsometer. The grafting temperature is 60° C. The dash line marked inside (FIG. 4C) and (FIG. 4E) represent the water CAH of 5°, it indicates a good liquid repellency of the surface if the CAH is less than 5°. The insets in (FIG. 4D) and (FIG. 4F) show the contact angles of water droplets on SLS. All the samples were fabricated by the vapor phase in a vacuum oven.

FIGS. 5A-5G. Super liquid repellency of SLS on various substrates. FIG. 5A: CA of water on different substrates before and after coated with SLS. FIG. 5B: CAH of toluene on SLS of different substrates. FIG. 5C: CAH and CA of various liquids on SLS of silicon. FIG. 5D: The temperature-dependent sliding velocity of 5 μL hexadecane on SLS with silicon substrate and SLIPS (AAO infused with Krytox101) at the tilted angle of 3°. FIG. 5E: Time-sequence images of ˜1 μL droplet of fluorocarbon liquid of FC72 (γ=10 mN m⁻¹) and 5 μL droplets of crude oil and mineral oil sliding down SLS at the tilted angle of 10°, scale bars are 1 mm. The volume of FC72 could not be accurately controlled due to the fast evaporation of the droplet. Liquid repellency of crude oil, mineral oil, and urine on (FIG. 5F) SLS silicon vs bare silicon, and (FIG. 5G) SLS aluminum foil vs bare aluminum foil. These three liquids could slide on SLS easily but wet on the bare surfaces.

FIGS. 6A-6G. Durable liquid repellency of water and organic liquids in harsh conditions. Comparison of water CAH on SLS (made on silicon) and SLIPS (black silicon infused with Krytox101) after (FIG. 6A) continuous abrasion tests with tissue paper, and FIG. 6B adhesion tests with adhesive tape. 200 g test weight was applied for abrasion (inset scheme in a) and adhesion tests (inset scheme in FIG. 6B). The inserted images in (FIG. 6A) and (FIG. 6B) show that water droplets were pinned on SLIPS after abrasion and adhesion test. While it remained slippery on SLS. Photos of (FIG. 6C) abrasion test, and (FIG. 6D) adhesion test. The repellency of water (dyed in purple) and hexadecane (dyed in orange) on SLS after (FIG. 6E) abrasion test, and (FIG. 6F) adhesion test for 1000 cycles. FIG. 6G: Liquid repellency of water and mineral oil on SLS after scratch damage.

FIGS. 7A-7G Two application examples of SLS: fog harvesting and self-cleaning. FIG. 7A: Schematics of PTFE-coated hydrophobic surface (HPS), SLS and SLIPS. FIG. 7B: Comparison of fog harvesting on three surfaces in 0-20 min. FIG. 7C: Durable fog harvesting for 253 min without losing surface lubrication on SLS. FIG. 7D: Fog harvesting rates on HPS, SLS and SLIPS. The insets present the water CA on different surfaces before and after the fog harvesting tests. The surfaces were positioned vertically during the fog harvesting tests by collecting water in 0-20 min and 240-260 min during fog harvesting. FIG. 7E: Variations of the average droplet shedding radius and shedding frequency on HPS, SLS and SLIPS in 0-20 min during fog harvesting. The insets show the images of shedding water droplets on three surfaces for size comparison. Scale bar: 2 mm. Self-cleaning of iron oxide particles on FIG. 7F: SLS (made on glass) with a water CA of 104.9°, and on FIG. 7G: superhydrophobic surface (SHS, made with commercial NeverWet® coating) with a water CA of 152.3° C. Iron oxide powder with a particle size<5 μm was used as “contaminant”. The substrate was tilted at 30°.

### REFERENCES

[1] T.-S. Wong, S. H. Kang, S. K. Tang, E. J. Smythe, B. D. Hatton, A. Grinthal, J. Aizenberg,
Nature. 2011, 477, 443.
[2] X. Deng, L. Mammen, H.-J. Butt, D. Vollmer, Science. 2012, 335, 67.
[3] A. Tuteja, W. Choi, M. Ma, J. M. Mabry, S. A. Mazzella, G. C. Rutledge, G. H. McKinley,
R. E. Cohen, Science. 2007, 318, 1618.
[4] T. Liu, C.-J. Kim, Science. 2014, 346, 1096.
[5] X. Dai, N. Sun, S. O. Nielsen, B. B. Stogin, J. Wang, S. Yang, T.-S. Wong, Sci. Adv. 2018, 4, eaaq0919.
[6] Y. Lu, S. Sathasivam, J. Song, C. R. Crick, C. J. Carmalt, I. P. Parkin, Science. 2015, 347, 1132.
[7] H. J. Cho, D. J. Preston, Y. Zhu, E. N. Wang, Nat. Rev. Mater. 2016, 2, 16092.
[8] A. K. Epstein, T.-S. Wong, R. A. Belisle, E. M. Boggs, J. Aizenberg, Proc. Natl. Acad. Sci. 2012, 109, 13182.
[9] S. Amini, S. Kolle, L. Petrone, O. Ahanotu, S. Sunny, C. N. Sutanto, S. Hoon, L. Cohen, J. C. Weaver, J. Aizenberg, Science. 2017, 357, 668.
[10] M. J. Kreder, J. Alvarenga, P. Kim, J. Aizenberg, Nat. Rev. Mater. 2016, 1, 15003.
[11] S. Pan, A. K. Kota, J. M. Mabry, A. Tuteja, J. Am. Chem. Soc. 2012, 135, 578.
[12] D. Bonn, J. Eggers, J. Indekeu, J. Meunier, E. Rolley, Rev. Mod. Phys. 2009, 81, 739.
[13] J. F. Oliver, C. Huh, S. G. Mason, J. Colloid Interface Sci. 1977, 59, 568.
[14] A. Giacomello, L. Schimmele, S. Dietrich, Proc. Natl. Acad. Sci. U.S.A. 2016, 113, E262.
[15] D. t Mannetje, S. Ghosh, R. Lagraauw, S. Otten, A. Pit, C. Berendsen, J. Zeegers, D. van den Ende, F. Mugele, Nat. Commun. 2014, 5, 3559.
[16] A. B. D. Cassie, S. Baxter, Trans. Faraday Soc. 1944, 40, 0546.
[17] R. N. Wenzel, Ind. Eng. Chem. 1936, 28, 988.
[18] A. Lafuma, D. Quéré, Europhys. Lett. 2011, 96, 56001.
[19] A. K. Epstein, T.-S. Wong, R. A. Belisle, E. M. Boggs, J. Aizenberg, Proc. Natl. Acad. Sci. U.S.A 2012, 109, 13182.
[20] M. Nosonovsky, V. Hejazi, ACS Nano. 2012, 6, 8488.
[21] N. Milijkovic, R. Enright, Y. Nam, K. Lopez, N. Dou, J. Sack, E. N. Wang, Nano Lett. 2013, 13, 179.
[22] B. J. Rosenberg, T. V. Buren, M. K. Fu, A. J. Smits, Phys. Fluids. 2016, 28, 015103.
[23] G. B. Hwang, K. Page, A. Patir, S. P. Nair, E. Allan, I. P. Parkin, ACS Nano. 2018, 12, 6050.
[24] X. Dai, B. B. Stogin, S. Yang, T.-S. Wong, ACS Nano. 2015, 9, 9260.
[25] D. J. Preston, Y. Song, Z. Lu, D. S. Antao, E. N. Wang, ACS Appl. Mater. Interfaces. 2017,
[26] F. Schellenberger, J. Xie, N. Encinas, A. Hardy, M. Klapper, P. Papadopoulos, H.-J. Butt, D. Vollmer, Soft Matter. 2015, 11, 7617.
[27] W. Chen, A. Y. Fadeev, M. C. Hsieh, D. Öner, J. Youngblood, T. J. McCarthy, Langmuir. 1999, 15, 3395.
[28] J. W. Krumpfer, T. J. McCarthy, Langmuir. 2011, 27, 11514.
[29] D. F. Cheng, C. Urata, B. Masheder, A. Hozumi, J. Am. Chem. Soc. 2012, 134, 10191.
[30] D. F. Cheng, C. Urata, M. Yagihashi, A. Hozumi, Angew. Chem. Int. Ed. 2012, 51, 2956; Angew. Chem. 2012, 124, 3010.
[31] L. Wang, T. J. McCarthy, Angew. Chem., Int. Ed. 2016, 55, 244; Angew. Chem. 2016, 128, 252.
[32] H. Hu, G. Liu, J. Wang, Adv. Mater. Interfaces. 2016, 3, 1600001.
[33] S. Wooh, D. Vollmer, Angew. Chem., Int. Ed. 2016, 55, 6822; Angew. Chem. 2016, 128, 6934.
[34] L. Yu, G. Y. Chen, H. Xu, X. Liu, ACS Nano. 2016, 10, 1076.
[35] D. H. Flagg, T. J. McCarthy, Langmuir. 2017, 33, 8129.
[36] P. Liu, H. Zhang, W. He, H. Li, J. Jiang, M. Liu, H. Sun, M. He, J. Cui, L. Jiang, X. Yao,
ACS Nano. 2017, 11, 2248.
[37] M. Boban, K. Golovin, B. Tobelmann, O. Gupte, J. M. Mabry, A. Tuteja, ACS Appl. Mater. Interfaces. 2018, 10, 11406.
[38] N. Singh, H Kakiuchida, T. Sato, R. Hönes, M. Yagihashi, C. Urata, A. Hozumi, Langmuir. 2018, 34, 11405.
[39] G. Zhang, B. Liang, Z. Zhong, Y. Huang, Z. Su, Adv. Mater. Interfaces. 2018, 5, 1800646.
[40] X. Zhong, H. Hu, L. Yang, J. Sheng, H. Fu, ACS Appl. Mater. Interfaces. 2019.
[41] S. Wooh, H. J. Butt, Angew. Chem., Int. Ed. 2017, 56, 4965; Angew. Chem. 2017, 129, 5047.
[42] R. A. L. Jones, Nat. Mater. 2003, 2, 645.
[43] M. Kuniyoshi, M. Takahashi, Y. Tokuda, T. Yoko, J. Sol-Gel Sci. Technol. 2006, 39, 175.
[44] D. Bodas, C. Khan-Malek, Microelectron. Eng. 2006, 83, 1277.
[45] M. Mahmoudi, H. Javaherian Naghash, J. Adhes. Sci. Technol. 2015, 29, 1341.
[46] A. Y. Fadeev, T. J. McCarthy, Langmuir. 2000, 16, 7268.
[47] C. Luap, W. A. Goedel, Macromolecules. 2001, 34, 1343.
[48] K.-C. Park, P. Kim, A. Grinthal, N. He, D. Fox, J. C. Weaver, J. Aizenberg, Nature. 2016, 531, 78.
[49] C. Furmidge, J. Colloid Sci. 1962, 17, 309.
[50] D. Baratian, R. Dey, H. Hoek, D. Van Den Ende, F. Mugele, Phys. Rev. Lett. 2018, 120, 214502.

### Supplemental Experimental Results

Various movies were collected to demonstrate different aspects of the disclosure.

Movie S1 showed the liquid repellency of semi-liquid surface and bare glass to low surface tension liquid Krytox101 oil (γ=17.0 mN m⁻¹) and water (γ=72.8 mN m⁻¹). The glass modified with semi-liquid surface maintains optical transparency and the liquids can slide off easily. However, the liquids leave a wetted footprint on the bare glass surface. The AFM images show the ultra-smooth surface of SLS compared to bare glass.

Movie S2 showed the side-view of sliding velocity of various liquids of FC72 (γ=10 mN m⁻¹), Krytox101 (γ=17 mN m⁻¹), acetone (γ=25.2 mN m⁻¹), and water (γ=72.8 mN m⁻¹) on the semi-liquid surface. To make the whole droplet of FC72 and Krytox101 to be seen in the screen, ˜1 μL FC72 and 2 μL Krytox101 is used instead of 5 μL droplets. The volume of FC72 could not be accurately controlled due to the fast evaporation of the droplet.

Movie S3 showed that the sliding velocity of hexadecane on the semi-liquid surface and the liquid-infused surface is increased with increasing of temperature. It demonstrates that the grafted semi-liquid polymers can significantly enhance the molecular mobility of the tethered PDMS molecular chains at elevated temperature, resulting in improved liquid repellency. However, the liquid-infused surface cannot survive at elevated temperature due to the lubricant loss.

Movie S4 showed that the semi-liquid surface made on either silicon or aluminum can easily repel different liquids even for complex fluids of crude oil and urine. In contrast, all these liquids spread on the bare substrates, leaving large wetted footprints. Here, water shows a fast sliding speed because: (i) water has a small viscosity, and (ii) the water droplet has a smaller contact area due to the larger contact angle compared with other liquids.

Movie S5 showed the durable liquid repellency of the semi-liquid surface to water and oil even after heating test at 105° C. for more than 3 months. It demonstrates that the grafted semi-liquid polymers of PDMS are highly thermostable due to the strong bond dissociation energy of Si—O between PDMS molecules and the substrate.

Movie S6 showed the durable liquid repellency of the semi-liquid surface to water and hexadecane even after 1000 cycles of abrasion tests, where a tissue paper adheres on the bottom of a 200 g load in the abrasion test. The semi-liquid surface shows low friction during the whole test.

Movie S7 showed the durable liquid repellency of the semi-liquid surface to water and hexadecane even after 1000 cycles of adhesion tests, where a strong adhesive tape adheres on the bottom of a 200 g load in the adhesion test. The semi-liquid surface shows low adhesion during the whole test.

Movie S8 showed the durable liquid repellency of the semi-liquid surface to water and mineral oil even after scratch tests, where a sharp knife is used to scratch the surface. Both water and oil droplets can slide off the scratched semi-liquid surface benefitting from the densely coated semi-liquid polymer layer of PDMS on the surface. Here we use mineral oil to show the SLS could repel a variety of hydrocarbon liquids.

Movie S9 showed the comparison of the fog harvesting performances of semi-liquid surface, PTFE-coated hydrophobic surface and liquid-infused surface (SLIPS), in which the semi-liquid surface shows durable and efficient fog harvesting property even after over 4 h. However, the SLIPS presents a lubricant loss on the surface after 4 h. And the hydrophobic surface shows low water harvesting rate during the whole process.

Movie S10 showed the comparison of the self-cleaning performances of semi-liquid surface, superhydrophobic surface (SHS), liquid-infused surface (SLIPS) and bare surface. At beginning, it presents that the SLS, SLIPS and SHS can repel water very well which indicates all these surface are in good condition before the self-cleaning experiment, while only SLS can repel low surface tension liquid of acetone. Then, iron oxide powder (with a particle size<5 μm) is used as “contaminant”. It demonstrates that the particles on a semi-liquid surface could be completely taken away by water droplets without leaving any dust, However, the other three surfaces cannot be self-cleaned.

Fabrication of Semi-Liquid Surface on Various Substrates: The semi-liquid surface is made by tethering flexible polymer molecules on a solid substrate with a one-step self-catalyzed grafting method. Specifically, the oxygen plasma-treated substrates were placed downward on a cover of petridish. Then the petridish (size: diameter 150 mm, height 15 mm) containing 800 μL of liquid Cl-PDMS-Cl was placed in a vacuum oven (0.15 Torr) at 60° C. for 60 min. The liquid should be dispersed uniformly on the surface of petridish by gently swing the petridish before placed into a vacuum oven. This one-step vapor phase method (i.e., no direct contact between the substrates and liquid reagent) could graft PDMS molecules on the solid substrates. Sequentially, the substrates were rinsed with abundant isopropyl alcohol (IPA), acetone, and water, successively. Note that liquid phase reaction (i.e., substrates are contacted with liquid reagent) could also be applied for successful grafting. All the SLS samples, unless specified, were prepared in the vapor phase with at 60° C. for 60 min (FIG. 8).

Fabrication of Control Surfaces: Hydrophobic surfaces, superhydrophobic surfaces, and liquid-infused surfaces were used for control studies. The chlorotrimethylsilane-coated hydrophobic glass slide was prepared by vapor phase in a vacuum oven at 60° C. for 12 h. This surface was used for morphology comparison with SLS on glass (FIGS. 3A-3G).

Polytetrafluoroethylene (PTFE)-coated silicon was fabricated by sputtering with a processing time of 20 min and power of 100 W. This surface was used as a hydrophobic surfaces for comparison with SLS and SLIPS for fog harvesting (FIGS. 7A-7G). Black silicon substrates were prepared according to the method reported in our previous work,[^{S1}] and then the sample was salinized using chlorotrimethylsilane. This surface was used for fabrication of SLIPS. Afterward, the salinized black silicon was infused with a lubricant, such as Krytox101 or mineral oil, and a spin coater (WS-650-23NPP, Laurell) was used to remove redundant lubricant for liquid infused surfaces (i.e., SLIPS). This surface was used for comparison with SLS for harsh durability tests of heating, abrasion, and adhesion (FIGS. 3A-3G and 6A-6G), and fog harvesting (FIGS. 7A-7G). To make transparent SLIPS (FIGS. 19A-19G), a thin layer of PDMS prepolymer mixed with the curing agent (10:1 ratio of the base and curing agent) was spin-coated on glass slides (2000 rpm, 30 s) and then was cured at 80° C. for 4 h. After that, the glass slides coated with organogel of PDMS were immersed in 10 cSt silicone oil for 48 h to completely expand the PDMS network for lubricant infusion.^{[S2]} Finally, the excess silicone oil on the surface was removed by spin coater (2000 rpm, 30 s) or by compressed air. This surface was used for comparison with SLS for the self-cleaning test (FIGS. 7A-7G). Superhydrophobic glass slides were made from commercial NeverWet® solution by two-step spray coating which was also used for comparison with SLS for the self-cleaning test (FIGS. 7A-7G).

Surface Characterization: All the substrates were treated in an oxygen plasma cleaner (PX-250, March Asher) for 20 min at 200 W with 200 mTorr O₂ gas before PDMS grafting. The optical transparency of these surfaces was studied using a Perkin Elmer Lambda 900 UV-Vis/NIR spectrophotometer with a wavelength range from 200 nm to 900 nm at a resolution of 1 nm. An FT-IR/ATR spectrometer (Nexus 4700, Nicolet) was employed to study the chemical compositions of the surfaces before and after grafted with PDMS polymer. Atomic force microscopy (AFM) measurement was carried out in tapping mode using a Nanoscope V controller on a multimode microscope (Multimode IV, Bruker). The thickness of SLS on silicon was characterized by the scanning electron microscope (SEM, Supra-40, Zeiss), as well as the Sentech 800 ellipsometer at an incident angle of 700 and with He—Ne laser as a light source (λ=632.8 nm). The Cauchy model was used to calculate the thickness, in which the thickness of the SiO₂ layer on oxygen plasma-treated silicon was used as the baseline layer. The average thickness was obtained by 5 independent measurements at different positions on SLS. A hot plate (PC-400D, Corning) was used for the high-temperature durability test at 105° C.

Contact Angle Measurements: The contact angle measurements were carried out using a contact angle measurement system (Model 290, Rame-hart) at room temperature under ambient conditions (20-22° C., ˜40% relative humidity). All the contact angle values were averagely derived from at least 5 independent measurements by applying ˜5 μL droplets on the test platform. For contact angle hysteresis measurement, the surface was tilted with respect to the horizontal plane until the liquid droplet starts to slide along the surface. Then, advancing, receding and sliding angles of the droplet were calculated by a computer program in which the drops were fitted into a spherical cap.

Fog Harvesting and Self-Cleaning Tests: To make a better comparison study for fog harvesting, hydrophobic surface (HPS, PTFE-coated silicon), SLIPS (mineral oil-infused black silicon) and the SLS (PDMS-grafted silicon), which has the same size of 1.4×3.3 mm, were vertically immobilized at the same height. A commercial ultrasonic humidifier (EE-5301, Crane) was used to produce mist. The fog flow was directed to the vertically hanged surfaces at an angle of 45°±5° and a distance between the mist outlet to the vertical substrates was ˜20 cm. Images of the absorbed water droplet could be obtained from the snapshots of the videos recorded using a digital single-lens reflex camera (D5600, Nikon) equipped with a zoom lens (AF Zoom-NIKKOR 24-85 mm f/2.8-4D IF Lens, Nikon). We can get the projections of the droplets, i.e. the width of the droplet (W), from the recorded images. We assume that the absorbed water droplet could be approximately fitted into the spherical cap, therefore the shedding radius (R) of the water droplet, i.e. the base contact radius of the droplet with the surface, can be calculated as R=W/2.^{[S3]} The shedding frequency (f) of water droplets was obtained by counting the number (N) of droplets that slid on the surface in a surface area of 7.5 cm² (3 cm×2.5 cm) over a period of time (t), which can be described as f=N/t. A clean beaker was placed under the drainage outlet of the substrate to collect the dripping water. The water collection was started after the first droplet slide off the surface. Then the weight of the beaker before (m₀) and after (m₁) water collection time (t) was measured by an analytical balance. The average fog harvesting rate could be calculated as (m₁−m₀)/(t−A),^{[S1]} where A is the surface area of the substrate and t is 5 min. All the fog harvesting data mentioned above was averagely calculated from at least 5 independent measurements. To make better visibility in the self-cleaning test, the transparent glass substrates were used, in which a superhydrophobic glass (NeverWet© coating), the SLIPS (organogel infused with silicone oil) and a clean glass slide were used as the comparison substrates for the SLS (PDMS-grafted glass). The similar amount of iron powder was sprinkled on the substrates and then was slightly pressed to imitate stubborn contaminant dust, then the substrates (with a tilted angle of 30°) were washed with continuous water drops. The digital camera was used to record the whole self-cleaning processes.

Materials Supply: Chlorine-terminated polydimethylsiloxane (Cl-PDMS-Cl, viscosity: 20-50 cSt at 25° C., M_{W}: 2000-4000), chlorotrimethylsilane (Me₃SiCl), silicone oil (viscosity: 10 cSt at 25° C.), PDMS silicone elastomer with a separate hydrosilane curing agent were all purchased from Gelest Inc. Fluorocarbon fluids of Krytox GPL 101 (Krytox101) and FC72 was obtained from Dupont Inc and Synquest Laboratories Inc, respectively. The other liquids which include ethanol (>99.0%), isopropanol (IPA, >99.5%), acetone (≥99.5%), tetrahydrofuran (THF, ≥, 99.9%), hexadecane (≥99%), toluene (≥99.5%), dimethylformamide (DMF, ≥, 99.8%), sulfuric acid (H₂SO₄, 95.9 wt %), triethylamine (TEA, ≥99%), urine were supplied by VWR Inc. White mineral oil was purchased from Sonneborn Inc. Crude oil sample originated from Denver/Julesburg Basin (USA) was provided by Brighton Colorado Weld Co. Iron (II, III) oxide powder (<5 μm, 95%) used as a contaminant in the self-cleaning test was purchased from Sigma-Aldrich Inc. Water-soluble dye of crystal violet (purple) and oil-soluble dye (orange) of Sudan I was supplied by VWR Inc. All chemicals were used as received without further purification. Tissue paper (1-Ply Light-Duty), double coated paper tape (401 M, 3M™), and plain microscope slides (25×75 mm, 1.1 mm thickness) were purchased from VWR Inc. Test weight (200 g) was purchased from McMaster-Carr Inc. Test grade p-type silicon wafers (100 orientation) were purchased with a diameter of 4 inches and thickness of ˜300 μm. Metal (Ti, Fe, Ni, Cr)-deposited silicon wafers were fabricated by the e-gun evaporator (Temescal 1800 e-beam evaporator) with a metal layer thickness of 100 nm, in which a 50 nm Cr was used as a binding layer for Ti, Fe and Ni layer. Commercial aluminum foil purchased from VWR Inc. was used without treatment. Deionized (DI) water was prepared by using a Milli-Q water purification system (Millipore).

TABLE S1
Comparison of liquid repellency for semi-liquid surface (SLS) fabricated
in this work and other omniphobic surfaces

| | CAH (Δθ) [°] | | |
|---|---|---|---|
| | Water | Hexadecane | |
| References | (72.8 mN m⁻¹)^{[a]} | (27.5 mN m⁻¹)^{[a]} | Fabrication Methods |
| Langmuir. 1999, 15, | −1 | −1 | Salination, |
| 3395.^{[S4]} | | | reduced pressure, |
| | | | 60-70° C., in hours. |
| Langmuir. 2011, 27, | 2 | 1 | High temperature |
| 11514.^{[S5]} | | | hydrolyzation and |
| | | | poly-condensation, |
| | | | 100° C., 24 h. |
| Angew. Chem. Int. Ed. | 4.6 | 2 | Hydrolyzation and Pt-catalyzed |
| 2012, 51, 2956.^{[S6]} | | | polycondensation, 50° C., 72 h. |
| Angew. Chem., Int. Ed. | 1 | 0.4 | Hydrolyzation and acid-catalyzed |
| 2016, 55, 244.^{[S7]} | | | polycondensation, |
| | | | 20-75° C., in seconds to minutes, |
| | | | humidity 60-70%. |
| ACS Nano. 2016, 10, | — | 12.0 | Layer by layer coating based on |
| 1076.^{[S8]} | | | electrostatic adsorption, |
| | | | room temperature, several |
| | | | rounds of grafting in hours. |
| ACS Nano. 2017, 11, | 41 | 1.3 | Sequence reactive grafting, |
| 2248.^{[S9]} | | | room temperature, several |
| | | | rounds of grafting in |
| | | | hours, anhydrous condition. |
| Adv. Mater. 2017, 29, | 8.6 | 1.7 | Photocatalyzed grafting based |
| 1604637.^{[S10]} | | | on TiO₂ containing lubricant, |
| | | | room temperature, in minutes, |
| | | | UV light. |
| Adv. Mater. Interfaces. | 4.5 | — | Karstedt-catalyzed polymerization, |
| 2018, 5, 1800646.^{[S11]} | | | 100° C., 1 h. |
| ACS Appl. Mater. | −8 | −5 | Base-catalyzed polycondensation and |
| Interfaces. 2018, 10, | | | spin coating, |
| 11406.^{[S12]} | | | 80° C., 12 h. |
| This work | 1.0 | 0.3 | Hydrolyzation and self-catalyzed |
| | | | polycondensation, |
| | | | 60° C., in minutes. |

^{[a]}Surface tension at 20° C.

TABLE S2
Surfaces prepared from chlorine-terminated PDMS polymer in different
conditions and their repellency to high surface tension liquid of water (72.8 mN m − 1 at 20° C.)

| | | | | | | | | | | | SA |
|---|---|---|---|---|---|---|---|---|---|---|---|
| | | | | | | | | | CA | CAH | (5/20 |
| | | Reaction | | | | | T | Time | (θ_{A}/θ_{R}) | (Δθ) | μL) |
| Sample | PDMS | Phase | Solvent | Additives | Humidity | Vacuum | [° C.] | [min] | [°] | [°] | [°] |
| 1^{#} | Cl- | Liquid | IPA | H₂SO₄ | 60-70% | None | 20 | 60 | 99.6/96.9 | 2.7 | 12/5 |
| | PDMS- | | | (acid | | | | | | | |
| | Cl | | | catalyst) | | | | | | | |
| 2^{#} | Cl- | Liquid | IPA | TEA | 60-70% | None | 20 | 60 | 96.4/84.5 | 11.9 | —/20 |
| | PDMS- | | | (alkaline | | | | | | | |
| | Cl | | | catalyst) | | | | | | | |
| 3^{#} | Cl- | Liquid | IPA | None | 60-70% | None | 20 | 60 | 103.8/99.6 | 4.2 | 14/7 |
| | PDMS- | | | | | | | | | | |
| | Cl | | | | | | | | | | |
| 4^{#} | Cl- | Liquid | None | None | 60-70% | None | 20 | 60 | 102.0/99.8 | 2.2 | 10/4 |
| | PDMS- | | | | | | | | | | |
| | Cl | | | | | | | | | | |
| 5^{#} | Cl- | Liquid | None | None | ~10% | Yes | 60 | 60 | 103.2/101.7 | 1.5 | 5/2 |
| | PDMS- | | | | | | | | | | |
| | Cl | | | | | | | | | | |
| 6^{#} | Cl- | Vapor | None | None | ~10% | Yes | 60 | 60 | 106.6/105.6 | 1.0 | 4/2 |
| | PDMS- | | | | | | | | | | |
| | Cl | | | | | | | | | | |

TABLE S3
Surfaces prepared from chlorine-terminated PDMS polymer in different
conditions and their repellency to low surface tension liquid of toluene (28.4 mN m⁻¹ at 20° C.)

| | | | | | | | | | CA | CAH | SA |
|---|---|---|---|---|---|---|---|---|---|---|---|
| | | Reaction | | | | | T | Time | (θ_{A}/θ_{R}) | (Δθ) | (5 μL) |
| Sample | PDMS | Phase | Solvent | Additives | Humidity | Vacuum | [° C.] | [min] | [°] | [°] | [°] |
| 1^{#} | Cl-PDMS-Cl | Liquid | IPA | H₂SO₄ | 60-70% | None | 20 | 60 | 25.6/23.9 | 1.7 | 2 |
| | | | | (acid catalyst) | | | | | | | |
| 2^{#} | Cl-PDMS-Cl | Liquid | IPA | TEA | 60-70% | None | 20 | 60 | 32.0/24.8 | 7.2 | 7 |
| | | | | (alkaline | | | | | | | |
| | | | | catalyst) | | | | | | | |
| 3^{#} | Cl-PDMS-Cl | Liquid | IPA | None | 60-70% | None | 20 | 60 | 29.8/27.4 | 2.4 | 3 |
| 4^{#} | Cl-PDMS-Cl | Liquid | None | None | 60-70% | None | 20 | 60 | 29.0/27.6 | 1.4 | 2 |
| 5^{#} | Cl-PDMS-Cl | Liquid | None | None | ~10% | Yes | 60 | 60 | 29.2/28.4 | 0.8 | 0.8 |
| 6^{#} | Cl-PDMS-Cl | Vapor | None | None | ~10% | Yes | 60 | 60 | 28.6/28.1 | 0.5 | 0.6 |

Various samples prepared from different reaction systems (with or without additives of solvents and catalysts) and multiple reaction conditions were studied to obtain the best preparation parameter for SLS. As shown in Table S1 and S2, the CAH to water and toluene, for different samples from sample 1^{#} to 6^{#}, were obtained by contact angle measurements. For samples 1^{#} and 2^{#}, Cl-PDMS-Cl and acid catalyst of H₂SO₄ or base catalyst of TEA were added into IPA with a mass ratio of 10:1:89 (Cl-PDMS-Cl: (H₂SO₄ or TEA): IPA) to form a coating solution. For sample 3^{#}, only Cl-PDMS-Cl was added into IPA with a mass ratio of 10:90. For sample 4^{#}, Cl-PDMS-Cl was used directly as a coating agent. Then, several drops of coating solutions from 1^{#} to 4^{#} were applied on four tilted hydroxylated silicon substrates with pipets, respectively. The reaction for 1^{#} to 4^{#} was carried out under 20° C. and dried for 60 min. For samples 5^{#} and 6^{#}, hydroxylated silicon substrate was placed in a petridish with (5^{#}) or without (6^{#}) contact with the liquid Cl-PDMS-Cl, i.e. liquid phase (5^{#}) or vapor phase (6^{#}) reaction, then the petridish was covered and placed into the vacuum oven heating at 60° C. for 60 min. After the reaction, all the samples were rinsed with abundant IPA, acetone, and water, successively. Finally, the contact angle measurements were carried out to obtain the best preparation parameters. Note that, either liquid phase reaction (sample 5^{#}) or vapor phase reaction (6^{#}) under reduced pressure at 60° C. could provide much lower CAH to water and toluene than others. Therefore, either the liquid phase or vapor phase under reduced pressure at 60° C. (5^{#} or 6^{#}) can be used as the best parameter for preparation of the SLS.

TABLE S4
Comparison of the CAs (θ_{A}/), CAHs (Δ θ), and the
sliding angles (SA) of different surface tensions droplets
(5 μL) on the semi-liquid surface (SLS).

| | Surface | CA | CAH | SA |
|---|---|---|---|---|
| | tension^{[a]} | (θ_{A}/θ_{R}) | (Δ θ) | (5 μL) |
| Liquid | [mN m⁻¹] | [°] | [°] | [°] |
| Water | 72.8 | 106.6/105.6 | 1.0 | 4.0 |
| DMF | 37.1 | 60.2/59.3 | 0.9 | 3.0 |
| Toluene | 28.4 | 28.6/28.1 | 0.5 | 0.6 |
| Hexadecane | 27.5 | 34.2/33.9 | 0.3 | 0.6 |
| THF | 26.4 | 23.1/22.8 | 0.3 | 0.5 |
| Acetone | 25.2 | 26.7/26.5 | 0.2 | 0.5 |
| Ethanol | 22.1 | 25.5/25.2 | 0.3 | 0.3 |
| Krytox101 | 17.0 | 31.8/31.1 | 0.7 | 0.5 |
| FC72 | 10.0 | 11.4/11.0 | 0.4 | <0.3^{[b]} |

^{[a]}Surface tension [mN m⁻¹] at 20° C.
^{[b]}The value of SA could not be accurately achieved due to the fast evaporation of the droplet.

FIG. 8. Schematic for preparation of SLS by vapor phase in a vacuum oven, in which hydroxylated substrate adhered on the inside wall of the petridish cover.

FIGS. 9A-C. AFM images of silicon (FIG. 9A) and glass (FIG. 9B) surface before and after PDMS grafting, where a lower roughness could be obtained after PDMS coating. FIG. 9C: SEM images of a cross-sectional view of silicon before and after PDMS grafting, where a˜30 nm PDMS polymer layer could be observed on SLS made on the silicon wafer substrate.

FIGS. 10A-B. The sliding angle (SA) of 5 μL water droplet on the SLS of silicon prepared in different coating temperatures (FIG. 10A), with coating time of 60 min) and different coating times (FIG. 10B), with coating temperature of 60° C.) in a vacuum oven.

FIG. 11. Schematics show the probable influence of temperature on the evaporation of liquid Cl-PDMS-Cl in vacuum oven. Combined with the water CAH data, a much lower evaporation rate should be presented when the temperature is less than or equal to 45° C. and that would be much higher when the temperature is higher than or equal to 60° C.

FIGS. 12A-G. The images of water (5 μL) contact angles on different substrates before and after PDMS coating. Notes that, all the PDMS-coated surfaces of SLS presented similar water CAs of ˜105° indicating a chemical homogeneity for PDMS coating layer on these surfaces.

FIGS. 13A-B: FIG. 13A: Time-sequence images for different droplets sliding down the SLS of silicon with the tilted angle of 10°. FIG. 13B: The sliding velocity of different liquids (5 μL) on the SLS of silicon with a tilted angle of 10°. The scale bars in (a) are 1 mm.

FIG. 14. The contact angle hysteresis (CAH) for water on the SLS made on metal surfaces.

FIGS. 15A-B: Time-sequence images show the hexadecane droplets sliding on the SLS (FIG. 15A) and SLIPS (FIG. 15B) under different temperatures.

FIGS. 16A-C: Schematic (FIG. 16A) and digital photos (FIG. 16B) of high-temperature aging test heating at 105° C. FIG. 16C: Liquid repellency of SLS to water (dyed in purple) and hexadecane (dyed in red) after high-temperature aging for over 3 months.

FIGS. 17A-B: Images show the surface of SLIPS (FIG. 17A black silicon infused with Krytox101) and SLS (FIG. 17B, PDMS-grafted silicon) before and after harsh durability tests of high-temperature aging, abrasion and adhesion for different durations.

FIG. 18. The water CAH of PTFE-coated hydrophobic surface (HPS), SLS and SLIPS before and after fog harvesting test for 260 min.

FIGS. 19A-G. The performance of the SLIPS and bare glass slides used for self-cleaning. FIG. 19A: Schematics of the structure of the transparent SLIPS which was made by spin coating of organogel on a glass slide and then infused with silicone oil. FIGS. 19B-C: The self-cleaning ability for SLIPS (FIG. 19B) and bare glass (FIG. 19C), in which both SLIPS and bare glass slides were contaminated after tests. Iron oxide powder (with a particle size<5 μm) was used as “contaminant” here. FIGS. 19D-E: The scheme for the superhydrophobic surface before (FIG. 19D) and after (FIG. 19E) contamination, in which the pollutants particles get into the microstructure on surface inducing the loss of ail lubricant. FIGS. 19F-G: The scheme for the liquid-infused surface before (FIG. 19F) and after (FIG. 19G) contamination, in which a liquid wrapping layer forms on contaminants.

### SUPPLEMENTARY REFERENCES

[S1] X. Dai, N. Sun, S. O. Nielsen, B. B. Stogin, J. Wang, S. Yang, T.-S. Wong, Sci. Adv. 2018, 4, eaaq0919.
[S2] C. Gao, L. Wang, Y. Lin, J. Li, Y. Liu, X. Li, S. Feng, Y. Zheng, Advanced Functional Materials. 2018, 28, 1803072.
[S3] R. Dey, J. Gilbers, D. Baratian, H. Hoek, D. Van Den Ende, F. Mugele, Appl. Phys. Lett. 2018, 113, 243703.
[S4] W. Chen, A. Y. Fadeev, M. C. Hsieh, D. Öner, J. Youngblood, T. J. McCarthy, Langmuir. 1999, 15, 3395.
[S5] J. W. Krumpfer, T. J. McCarthy, Langmuir. 2011, 27, 11514.
[S6] D. F. Cheng, C. Urata, M. Yagihashi, A. Hozumi, Angew. Chem. Int. Ed. 2012, 51, 2956; Angew. Chem. 2012, 124, 3010.
[S7] L. Wang, T. J. McCarthy, Angew. Chem., Int. Ed. 2016, 55, 244; Angew. Chem. 2016, 128,
252.
[S8] L. Yu, G. Y. Chen, H. Xu, X. Liu, ACS Nano. 2016, 10, 1076.
[S9] P. Liu, H. Zhang, W. He, H. Li, J. Jiang, M. Liu, H. Sun, M. He, J. Cui, L. Jiang, ACS Nano. 2017, 11, 2248.
[S10] S. Wooh, N. Encinas, D. Vollmer, H. J. Butt, Adv. Mater. 2017, 29, 1604637.
[S11] G. Zhang, B. Liang, Z. Zhong, Y. Huang, Z. Su, Adv. Mater. Interfaces. 2018, 5, 1800646.
[S12] M. Boban, K. Golovin, B. Tobelmann, O. Gupte, J. M. Mabry, A. Tuteja, ACS Appl. Mater. Interfaces. 2018, 10, 11406.

Further experiments were performed to examine the relationship between ice adhesion strength and water CAH, for SLS formed using various PDMS oligomer molecular weights and viscosity as grafted on example glass substrate embodiments of the disclosure (FIG. 20).

The PDMS oligomer molecule used for the fabrication of the SLS on the substrate was trimethylsiloxy-terminated PDMS oligomers (“CH₃-terminated PDMS”). The same types of PDMS oligomers, but each with different viscosities and molecular weights, were studied. Specifically, the PDMS oligomers had viscosities of: 20, 50, 100, 200, 500, 1000, 5000, 30000, and 100000 cSt, and corresponding molecular weights of: 2000, 3780, 5970, 9430, 17250, 28000, 49350, 91700, and 139000 g/mol, respectively. Pristine glass slide substrates were washed with acetone, and treated with oxygen plasma for 10 minutes in accordance with step 120. The plasma-treated glass slides were then immersed for 12 hours in the CH₃-terminated PDMS liquid of each of the various molecular weights mentioned above, and the reaction was carried out at room temperature, in accordance with steps 110 and 115.

This was followed by rinsing of the PDMS polymer grafted glass substrates with toluene for another 12 hours inside a shaker (step 130), to wash away the un-grafted free PDMS oligomers from the substrate. The free PDMS oligomers were substantially completely rinsed off as indicated by the absence of the visual appearance of any liquid on the surface. As disclosed elsewhere herein, in the context of step 130, it can be beneficial if the free PDMS oligomers are not completely removed since this can beneficially result in interfacial free molecules and thereby enhance liquid or ice removal. The amounts of such interfacial free molecules can, if desired, be manipulated by changing the rinsing time from e.g., 0 to 12 hours to adjust the relative amount of free PDMS oligomer left of the grafted substrate surface.

The substrates with a SLS formed thereon were then air dried, and used for further study to measure the CAH for water droplets and assess ice removal performance. The CAH values were averaged from at least 5 independent measurements by applying ˜10 μL droplets on the test substrate. The ice adhesion strength values were averaged from at least 5 independent measurements on the test substrate.

As illustrated in FIG. 20 (open symbols), the SLS substrates were omniphobic with low contact angle hysteresis (CAH) and low sliding angle (SA). The liquid repellency property of the SLS was been confirmed for liquids of low surface tension like acetone and toluene, as well as perfluorinated liquid like Krytox101, FC40, HFE7100, FC72, R134a and R410A. The CAH for water followed an increasing trend with increasing viscosity/molecular weight of the PDMS polymer used.

As illustrated in FIG. 20 (closed symbols), ice removal performance of the SLS substrates showed a parabolic curve as a function of the viscosity/molecular weight of the PDMS oligomers used, with the lowest ice adhesion strength recorded for the sample with a molecular weight 17,250 g/mol (viscosity 500 cSt) (τ=22.6±4.8 kPa), and, the CAH was also less than 4° on the substrate with a SLS formed using this molecular weight of PDMS oligomer. As illustrated, for lower molecular weights (2,000 to 9,430 g/mol) the CAH was less than 4° and the ice adhesion strength remained at or below about 75 kPa. At higher molecular weights (>28,000 g/mol) the CAH begins to increase, which we theorize to be reflective of increasing degrees of entanglement between the PDMS polymers tethered to the substrate and increasing loss of the SLS like properties believed to facilitate liquid repellency. However, up to a molecular weight of 91,700 the CAH remained below about 6° and the ice adhesion strength remained at or below about 75 kPa, and, even for a molecular weight of 139,000 g/mol, the CAH and ice adhesion strength were less than that of bare glass. From this parametric study, the CH₃-terminated PDMS oligomer with molecular weight 17,250 g/mol (viscosity 500 cSt) appears to be a good, or even optimum, choice of this type of PDMS oligomer for fabrication of a SLS on the substrate.

Further experiments were conducted to examine the relationship between water CAH, PDMS oligomer molecular weight and viscosity for SLS grafted on example Aluminum substrate embodiments (FIG. 21).

Aluminum foil was used as a substrate. Aluminum foil pieces were cut into 3 cm×3 cm sizes, and then immersed for 12 hours in solutions containing the CH3-terminated PDMS oligomer liquids with viscosities of one of: 50, 100, 200, 500, 1000, 5000, 30000, and 100000 cSt, and the same corresponding molecular weights as described above. The Aluminum foil was used as received, without any plasma treatment (e.g., no step 120). During immersion in the PDMS oligomer liquids, the Aluminum foil substrates were kept at room temperature. This was followed by rinsing of the substrates with toluene for another 12 hours inside a shaker to ensure removal of ungrafted free PDMS oligomers (step 130). The Aluminum foil with the SLS thereon were then air dried, and used for studying liquid repellency performance.

The SLS thus prepared was omniphobic as represented by CAH (FIG. 21) and low sliding angle (data not shown). The CAH data for water on these surfaces followed a parabolic trend as shown in FIG. 21. E.g., SLS substrate grafted with the 500 cSt PDMS oligomer had a CAH value of 6.2°±0.5°. All the data presented in FIG. 21 were averaged from at least 5 independent measurements by applying ˜10 μL droplets on the test substrate. While water was used to confirm that the SLS was successfully grafted to the substrate, the liquid repellent functionality can extend from water to organic liquids or other complex fluids, similar to that described elsewhere herein.

Further experiments were performed to examine ice adhesion strength of a SLS grafted using a semi-liquid solvent mixtures with different ratios of PDMS and inert liquid on example glass substrate embodiments of the disclosure (FIG. 22).

Heptane was used as the inert liquid to lower the viscosity of the CH3-terminated PDMS oligomer and reduce the cost to make it more suitable for use as a spray solvent. For initial studies, the solvent was prepared by mixing CH3-terminated PDMS oligomer liquid having a viscosity of 500 cSt (MW=17,250 g/mol) with n-heptane in a volume ratio of 1:10 PDMS oligomer:heptane. When compared with the semi-liquid surface fabricated on glass with the mixture ratio of 1:0 (i.e., pure PDMS oligomer), both surfaces showed an ice adhesion strength with similar values as shown FIG. 22. These data are from 12-hour immersion time, followed by 12 hour rinsing time. The data shows that the mixture of PDMS and n-heptane can produce a SLS graft on a substrate with similar ice adhesion strength functionality similar to a SLS graft on a substrate using pure PDMS. While we use n-heptane as the example inert liquid, other inert liquids can also work, as discussed elsewhere herein.

In another experiment the mixture of CH3-terminated PDMS oligomer liquid and heptane (ratio of 1:10 PDMS:n-heptane) was used as a spray solution to form a SLS graft on a glass substrate that was not given a plasma treatment (e.g., no step 120). A pristine glass slide without any plasma treatment was sprayed with the mixture and allowed to stand for 12 hours. Then, the glass slide was rinsed with toluene for 5 minutes in a shaker (step 130). The substrate with the SLS grafted thereon had a water CAH of 4.10±0.4°, and a ice adhesion strength of 3.96 kPa. These results demonstrate that a solution of PDMS and inert liquid can be applied to the substrate surface, without a plasma treatment, to produce a SLS on a glass substrate. Without limiting the scope of the disclosure by theory, we believe that aluminum and glass substrates, or other substrates with oxide layers thereon (e.g., metal oxide, silicon oxide, titanium oxide, zinc oxide, etc. . . . ) can provide natural or inherent hydroxylated surfaces with sufficient hydroxy functional groups thereon for successful PDMS grafting, thus greatly expanding the utility of the method and formation SLS grated articles as disclosed herein.

Those skilled in the art to which this application relates will appreciate that other and further additions, deletions, substitutions and modifications may be made to the described embodiments.

1. A method, comprising:
providing a substrate having a surface, wherein the surface is hydroxylated; and
exposing the hydroxylated surface of the substrate to a PDMS oligomer, the PDMS oligomer having a formula of:
R₁—Si(CH₃)₂—(O—Si(CH₃)₂—)ₙ—O—Si(CH₃)₂—R₂
wherein:
at least one of the R₁ or the R₂ includes: —(CH₂)ₘ—R₃,
the R₃ is one of —Cl, —O—(CH₂)ₓH, —SiCl₃, or —Si(O—(CH₂)ₓH)₃
the x is an integer in a range from 0 to 10,
the m is an integer in a range from 0 to 10,
the n is an integer in a range from 10 to 500, and
the R₃ of the PDMS oligomer undergoes hydrolysis such that one terminal Si atom of the PDMS oligomer is covalently bonded to the hydroxylated surface by a condensation reaction to form a grafted layer of PDMS polymers on the surface.

2. The method of claim 1, wherein the R₁ and the R₂ both have same ones of the R₃.

3. The method of claim 1, wherein the R₁ and the R₂ have different ones of the R₃.

4. The method of claim 1, wherein one of the R₁ or the R₂ has the —(CH₂)ₘ—R₃ and the other one of R₁ or the R₂ includes —(CH₂)ₒCH₃ where the o is an integer in a range from 0 to 10.

5. The method of claim 1, wherein providing the substrate includes providing a substrate composed of silicon, glass, cross-linked PDMS organogel, Al, Ti, Fe, Ni or Cr metal or multilayered combinations thereof.

6. The method of claim 1, wherein the exposing is for a time period is a range from 5 to 720 minutes.

7. The method of claim 1, wherein the exposing occurs inside a container holding the substrate therein.

8. The method of claim 7, wherein the container is configured to maintain a temperature value in a range from 20 to 100° C. inside the container.

9. The method of claim 7, further including an acid vapor in the container.

10. The method of claim 1, wherein the exposing includes exposing to the PDMS oligomer in a liquid phase.

11. The method of claim 10, wherein a concentration of water in the liquid phase is less than 1 weight %.

12. The method of claim 1, further including forming the hydroxylated surface on the substrate surface, including exposing the substrate surface to an oxygen plasma treatment, a corona treatment, a strong oxidizing solution or combination thereof.

13. The method of claim 16 wherein:
the oxygen plasma treatment includes applying a power setting in a range from about 20 to 300 W, a O₂ pressure in a range from about 50 to 300 mTorr and a treatment duration time in a range from about 0.5 to 30 minutes;
the corona treatment includes applying a power setting in a range from about 20 to 300 W and a treatment duration time in a range from about 0.5 to 30 minutes, or
the strong oxidizing solution includes a mixture of sulfuric acid (H₂SO₄) and hydrogen peroxide (H₂O₂) and an exposure duration time in a range from about 0.5 to 30 minutes.

14. The method of claim 1, further including adding liquid PDMS molecules on the surface with the grafted layer of PDMS polymers thereon.

15. An article, comprising:
a substrate having a surface with a grafted layer of PDMS polymers thereon, wherein each of the PDMS polymers have a formula of:
-Q₁-Si(CH₃)₂—(O—Si(CH₃)₂—)ₙ—O—Si(CH₃)₂-Q₂
wherein:
the Q₁ is one of —O— or —O—(CH₂)ₘ—O—
the Q₂ is -(-Q₁-Si(CH₃)₂—(O—Si(CH₃)₂—)ₙ—O—Si(CH₃)₂-)ₚ-Q₃
the Q₃ is one of —OH, —(CH₂)ₘ—OH, —Si(OH)₃, or —(CH₂)ₘ—Si(OH)₃
the m is an integer in a range from 0 to 10,
the n is an integer in a range from 10 to 500,
the p is an integer in a range from 0 to 500, and
the Q1 is an end of the PDMS polymer covalently bonded to the surface.

16. The article of claim 15, wherein the grafted layer of PDMS polymers has a thickness value in a range from 10 to 40 nm.

17. The article of claim 15, wherein the treated surface with the grafted layer of PDMS polymers thereon has a surface roughness of 1 nm or less.

18. The article of claim 15, wherein a droplet of water on the grafted layer of PDMS polymers thereon has a contact angle hysteresis in a range from 0 to 5 degrees.

19. The article of claim 15, wherein the surface with the grafted layer of PDMS polymers thereon further includes liquid PDMS molecules on the surface the grafted layer of PDMS polymers.

20. The article of claim 15, wherein the surface with the grafted layer of PDMS polymers thereon is part of a surface of a: pipeline, a land air or water-born vehicle, a window, a window cleaning blade, a wind turbine blade, a heat transfer device or an article of clothing.

21. The method of claim 1, wherein the condensation reaction to form the grafted layer of PDMS polymers on the surface includes a self-catalyzed condensation reaction by HCl auto-generated from the hydrolysis.
